(19) United States
(12) Patent Application Publication
(10) Pub. No.: US 2015/0075065 A1
(43) Pub. Date: Mar. 19, 2015

(54) METHOD FOR PROCESSING ORGANIC PHASE SUBSTANCE BY USING HALOGEN-CONTAINING CHECICAL OR CHEMICALS AND/OR MIXTURE CONTAINING OXYGEN-CONTAINING OXIDIZER OR OXIDIZERS AND ORGANIC CARBONYL ANALOGUE OR ANALOGUES, AND/OR METHOD FOR EXTRACTING OR DEPOSITING HEAVY ELEMENT SPECIES AND/OR ORGANIC COMPONENTS OF ASPHALTENE AND/OR INORGANIC SUBSTANCE FROM THE ORGANIC PHASE SUBSTANCE BY USING HALOGEN-CONTAINING CHEMICAL OR CHEMICALS AND/OR MIXTURE CONTAINING OXYGEN-CONTAINING OXIDIZER OR OXIDIZERS AND ORGANIC CARBONYL ANALOGUE OR ANALOGUES, AND PLANT USING FOR THE METHOD, AND ORGANIC PHASE SUBSTANCE

(71) Applicant: NATIONAL INSTITUTE OF ADVANCED INDUSTRIAL SCIENCE AND TECHNOLOGY, Tokyo (JP)

(72) Inventors: Tooru Nakamura, Tsukuba-shi (JP); Yutaka Hayashi, Tsukuba-shi (JP); Akira Suzuki, Tsukuba-shi (JP); Richard Brommeland, Edmonton (CA); Andrew Myles, Edmonton (CA)

(73) Assignee: NATIONAL INSTITUTE OF ADVANCED INDUSTRIAL SCIENCE AND TECHNOLOGY, Tokyo (JP)

(21) Appl. No.: 14/523,734

(22) Filed: Oct. 24, 2014

Related U.S. Application Data
(63) Continuation of application No. PCT/JP2013/062503, filed on Apr. 26, 2013.

(30) Foreign Application Priority Data
Apr. 26, 2012 (JP) 2012-100883

(51) Int. Cl. C10G 21/08; C10G 21/20; C10C 1/18; C10C 1/20; C10C 3/04; C10C 3/08; C10L 9/00; C10L 9/06; C08L 95/00; C01G 31/02; C01G 53/04; C22B 34/22; C22B 23/00; C22B 34/32; C22B 34/12; C22B 30/04; C22B 3/00; C10G 53/14

(52) U.S. Cl. CPC C10G 21/08; C10G 53/14; C10G 21/20; C10C 1/18; C10C 1/20; C10C 3/04; C10C 3/08; C10L 9/00; C10L 9/06; C08L 95/00; C01G 31/02; C01G 53/04; C22B 34/22; C22B 23/00; C22B 34/32; C22B 34/12; C22B 30/04; C22B 3/00; C10L 2290/544
USPC 44/621; 208/391; 208/45; 208/251 R; 208/252; 208/22; 208/14; 208/390; 208/253; 423/592.1; 423/1; 420/424; 420/8; 420/441; 420/428; 420/417; 420/579

(57) ABSTRACT

The invention provides a processing method for upgrading an organic phase substance by removing heavy element species from the organic phase substance originating from a resource substance in mild environmental conditions, and further provides a method for collecting removed heavy element species and a method for collecting other substances.

The invention is constituted of a method for processing an organic phase substance, including: allowing an organic phase substance to coexist with a water phase, wherein the organic phase substance contains at least organic components originating from one or more selected from crude oil, bitumen, tar, residual fuel oil, petroleum residue, oil sands, tar-sand, asphaltene, fossil strata, cokes, oil-shale and coal, and contacting resultant of the above coexistence with halogen-containing chemical or chemicals, thereby extracting or depositing the heavy element species from the organic phase substance into the water phase; a plant for the method; and substances collected by the method.

### TECHNICAL FIELD

The present invention relates to an effective processing method for separating and removing heavy element species such as vanadium (e.g., vanadium oxide, such as V₂O₅ and VO₂ and other oxide complexes), nickel, and other transition metal ions, from organic phase substances originating from e.g., crude oil, bitumen, tar, asphaltene, oil sands, tar-sand, residual fuel oil, petroleum residue, fossil strata, cokes, oil-shale or coal so as to improve the quality of the organic phase substance used as a resource, and/or for collecting and concentrating constitutive heavy element species including oxidized heavy metals, ions, elemental metals, alloys or mixtures of these. These collected heavy element species are also utilized as resources.

Furthermore the present invention is also associated with effective process methods in order to separate and remove organic components of asphaltene included in crude oil, bitumen, tar, oil sands, tar-sand, residual fuel oil, petroleum residue.

### BACKGROUND ART

It is important to effectively remove heavy element species in oil sands or bitumen or tar or crude oil for preventing catalysts from being damaged and inactivated or for preventing the bad efficiency in upgrading processes, in other words, hydrocracking or hydrodesulfurization or hydrodenitrogenation reaction performed in the oil-related industries from degrading.

Under unstable worldwide economic situation, in order to keep diversified supply routes for mine resources based on the fair trade system, it is also crucial to collect heavy element species as a mineral resource from bitumen or tar or crude oil or coal or oil-shale present in oilfield and oil mine, etc.

On the other hand, it is well known that an organic phase substance such as heavy oil, bitumen or tar or crude oil contains a vanadium oxide, as an organic porphin derivative, i.e., a kind of vanadium complex of a porphyrin derivative having a tetrapyrrole ligand (as to appearance of porphin or porphyrin derivatives in oil, see, for example, Non Patent Literatures 1 and 2). These are quite stable.

Depending on the circumstances, a technique for removing metal ions using hydrogen peroxide in supercritical water at a temperature as high as beyond 374° C. and a pressure as high as beyond 218 atm. has been filed by Hitachi (Patent Literature 1). It is reported that only organic acids react with vanadyl porphin at a high temperature over 120° C. to release presumably a vanadium oxide into a water phase (Non Patent Literature 3).

Chemicals mixed with organic acid or phosphoric acid were applied to the removal of vanadium complexes from heavy oil at the temperature over +100° C., combining the other compounds (Patent Literatures 2, 3). It should be noted that high electric fields were applied in the system in the case of Patent Literature 3. Strong acids and the other chemicals such as sulfuric acid and FeCl₃ or SnCl₄ were used for the removal of vanadium metal ions of oil residue at the temperature over +100° C. (Non Patent Literature 4).

These literatures and related inventions are applicable to removing and collecting heavy element species from an organic phase substance, such as crude oil, bitumen, tar, or residual fuel oil; however all these techniques require complicated operation procedures and huge energy, more specifically, heat, high pressure and high electric field. As a result, initial investments in plants and equipment and running cost have been increased. These techniques are not free from these drawbacks.

### CITATION LIST

### Patent Literature

[Patent Literature 1] Japanese Patent Laid-Open No. 2003-277770
[Patent Literature 2] Chinese Patent Publication No. 101215477
[Patent Literature 3] Chinese Patent Publication No. 101469279

### Non Patent Literature

[Non Patent Literature 1] M. C. Sheppard, J. S. Edwards, “Athabasca Oil Sands, From Laboratory to Production”; Part One, Introduction; Geoscience Publishing: Alberta, Canada (2005).
[Non Patent Literature 2] R. H. Fish, J. Komlenic, J., Anal. Chem. 1984, 56(3), 510-517.
[Non Patent Literature 3] J. G. Reynolds, Prepr. Pap.-Am. Chem. Soc., Div. Fuel Chem. 2004, 49(1), 79-80.
[Non Patent Literature 4] S. Abbas, Z. T. Maqsood, M. F. Ali, Petroleum Science and Technology, 2010, 28, 1770-1777.

### SUMMARY OF INVENTION

### Technical Problem

In the circumstances, an object of the present invention is to provide a processing method for upgrading organic phase substances by removing heavy element species from the organic phase substance originating from resource substances in mild environmental conditions that do not require conventional high temperature, high pressure and high electric field, and further to provide a method for collecting removed heavy element species and a method for collecting other useful substances, further to provide heavy element species, refined organic phase substance produced by using these methods, further to provide an apparatus and plant employing these processing methods, and additionally to provide means for recycling substances used in the processing methods and the plant.

### Solution to Problem

Firstly “words” used in this description are explained to prevent from confusing and misunderstanding.

The “organic phase substance” described in the invention refers to a substance present in a liquid phase including a syrupy substance or a substance present in a solid phase including powers, shots, lumps having an average diameter of less than 1 m, and small pieces, or a mixture of these at least constituted of an arbitral organic component. The organic phase substance sometimes accompanies with an inorganic substance and water other than organic components.

The “organic components” as a mixture directly means all kinds of resource substances selected from one or more selected from all kinds of crude oils, all kinds of bitumens, all kinds of tars including Orinoco tar or crop-, plant-converted tars, heavy oil, all kinds of oil sands, tar-sand, fossil strata containing porphyrin derivatives, cokes, oil-shale or coal stored in Canada, North Europe, USA, Mexico, South America including Brazil and Venezuela, Australia, Africa (Congo, Madagascar), Middle East, Russia, and Asia including southeast countries and China.

Furthermore, the “organic components” as a mixture refer to substances obtained by applying all processes such as heating or upgrading or conversion to these resource substances. More specifically, the “organic components” refer to tar or bitumen residue, asphaltene, heavy oil, residual fuel oil and petroleum residue obtained by processing, mixing with organic solvents or combining with other organic components originating from these resource materials.

Furthermore, the organic phase substance described in this invention sometimes accompanies a water phase in the range from a low-level concentration (about ppt) to a high level concentration (in terms of volume percent) twice as high as the low level concentration, based on weight or volume of the organic phase substance, and possibly contains one or more of all types of inorganic substances such as sand, soil, mud, tailing and the like. The organic phase substance sometimes contains organic components as heavy as beyond an average molecular weight of 750.

The “water phase” described in this specification refers to a liquid at least constituted of hydrogen oxide, i.e., water, which originates from a solution resulting from warm water injected to soften oil sands and tar, a solution resulting from a river or lake or pond including tailing pond or sea water of an actual industrial land or soil soaked in water, containing an alkali metal chloride and/or an alkali earth metal chloride or an arbitral aqueous solution prepared from underground water or city water.

The water phase is previously present before the method of the present invention is carried out or added after the method of the present invention is carried out. The water phase often contains additives such as nitrogen-organic compounds or organic acid derivatives or other impurities.

More specifically the “water phase” includes any kinds of aqueous solution mainly based on water containing all solutes, compounds, micelles, colloids and also includes emulsions and suspensions having complicated phases.

The “substance” refers to all substances used in the present invention such as halogen-containing chemical or chemicals, oxygen-containing oxidizer or oxidizers, chemical or chemicals such as organic carbonyl analogue or analogues, organic phase substances, heavy element species, organic components of asphaltene and/or inorganic substances.

The processing method of the present invention mainly uses a two-phase solution, meaning a two-phase system consisting of an organic phase substance and a water phase, as shown in FIG. 3. As to a specific procedure, any manner may be employed without problems as a method for contacting or mixing organic phase substances with the chemical or the chemicals to be used in the present invention. Any procedure is sufficiently employed as long as organic phase substances are basically and appropriately contacted or mixed with chemical or chemicals, no matter how they are contacted or mixed with each other.

For example, “contacting” means that an organic phase substance is exposed to vapor of chemical or chemicals, or vapor of the chemical or the chemicals are sent into an organic phase substance by bubbling, or an organic phase substance is contacted with chemicals at the interface with a water phase containing the chemical or the chemicals. For example, to mix is mixing organic phase substance with chemical or chemicals by using mixer, or stirrer, or propeller, or waterwheel, or sonicator, or sprayer.

A unit of “atm” means atmospheric pressure, i.e., 1 atm=0.1 MPa, and 10 atm=1 MPa.

“Organic components” in the description of this invention mean that any organic, carbon-based molecules such as organic molecules, e.g., hydrocarbons having any substituents, or porphyrin, phthalocyanine and chlorophyll derivatives, or these metal complexes, and relatively complicated oligomeric or polymeric or graphite-like or diamond-like compounds, included in crude oil, bitumen, tars including Orinoco tar, heavy oil, residual fuel oil, petroleum residue, oil sands, tar-sand, asphaltene, fossil strata, cokes, oil-shale, or coal, or any organic molecules originating from these resource substances, e.g., before or after heating or processing or upgrading these resource substances.

Particularly, in the specification, the organic components of asphaltene refer to organic components in the organic phase substance, which sometimes cause a problem in oil processing, having relatively large molecular weights and associated with asphaltene, heavy oil, residual fuel oil, petroleum oil or tar residue and having relatively low solubility and associated with asphaltene, heavy oil, residual fuel oil, petroleum oil or tar residue.

The “halogen-containing chemical or chemicals” described in this invention mean all kinds of reactive chemical or chemicals including fluoride, chlorine, bromine and iodine. Specifically, the “chlorine-containing chemical or chemicals” refer to chlorine gas (Cl₂) and/or interhalogen compounds such as chlorine-monofluoride (Cl—F) and chlorine monoiodide (Cl—I) and/or chlorine radical (Cl.) and/or oxidized chlorine species (Cl—Oₓ) such as hypochlorite, chlorite, chlorate and perchlorate. The “bromine-containing chemical or chemicals” refer to bromine gas or liquid (Br₂) and/or interhalogen compounds such as bromine-monoiodide (Br—I) and/or bromine radical (Br.) and/or oxidized bromine species (Br—Oₓ) such as bromate derivatives. The “iodine-containing chemical or chemicals” refer to a mixture of iodine (I₂) and one or more iodide chemical or chemicals selected from oxidized iodine species (I—Oₓ) such as sodium periodate or periodic acid or iodine cation (Iₙ⁺, n≧1) or radical (I) species.

The “transition metal catalyst” refers to a catalyst, which is used in a reaction such as a hydrodehalogenation reaction (hydro-defluorination reaction, dechlorination reaction, debromination reaction, deiodination reaction), a hydrodesulphurization reaction and a hydrodenitrogenation reaction, for upgrading a liquid-state organic phase substance such as bitumen and tar, and which is, for example, consists of iron, palladium, rhodium, iridium, platinum or molybdenum.

The “hydroxide anion” refers to an anion having an OH⁻ structure, which is a causal structure exhibiting alkalinity in a water phase and can be used for neutralizing proton H⁺ in the water phase.

In the present invention, the “halogen” refers to fluorine, chlorine, bromine and iodine belonging to the 17th group of the periodic table. The “halogenation” refers to formation of a covalent bond between one or more halogen atoms selected from fluorine, chlorine, bromine and iodine and a carbon atom(s).

The “halide ion” refers a halide anion such as F⁻, Cl⁻, Br⁻ and I⁻. The “hydrodesulphurization reaction” refers to a reaction for removing sulfur chemically binding to an organic component in an organic phase substance using hydrogen gas and/or an alcohol and a hydroxide anion in the presence of a transition metal catalyst. The “hydrodenitrogenation reaction” refers to a reaction for removing nitrogen chemically binding to an organic component in an organic phase substance using hydrogen gas and/or an alcohol and a hydroxide anion in the presence of a transition metal catalyst. The “hydrodehalogenation reaction” refers to a reaction for removing halogen chemically binding to an organic component in an organic phase substance using hydrogen gas and/or an alcohol and a hydroxide anion in the presence of a transition metal catalyst.

The “alcohol” refers to all hydroxyl organic substances represented by a structural formula, ROH, and includes also sugar, and sucrose. In the present invention, the hydrodehalogenation reaction is preferably performed using, particularly, a secondary alcohol such as isopropyl alcohol (isopropanol).

The “oxygen-containing oxidizer or oxidizers” consist of classes (i) and (ii). The class (i) includes oxidizer or oxidizers having an oxygen-oxygen bond excluding O₂, more specifically includes peroxides and/or ozone and/or other oxidizer or oxidizers having an oxygen-oxygen bond and having relatively strong oxidizing ability; whereas the other class (ii) includes oxidizer or oxidizers other than those mentioned above.

Examples of the oxidizer or oxidizers (i) include hydrogen peroxide H₂O₂ and/or ozone O₃ and/or peroxycarboxylic acids RCO₃H such as meta-chloroperoxybenzoic acid, alkane peroxycarboxylic acid and other organic peroxycarboxylic acids and/or organic peroxides RO—OR, and/or ketone peroxides such as acetone peroxide.

Examples of the oxidizer or oxidizers (ii) include chromic oxides such as chromic oxide (VI) CrO₂ and dichromic acid Cr₂O₇, and/or transition metal oxides such as osmium oxide OsO₄, and/or sulfur oxide compounds (SOₓ (x>2)), and/or 7,7,8,8-tetracyanoquinodimethane TCNQ derivatives having a strong electron attracting group, such as a cyano group and a nitro group.

The “organic carbonyl analogue or analogues” include organic derivatives having a carbonyl-type substituent having an oxygen-hetero atom double bond, such as organic carboxylic acids, sulfinic acids, sulfonic acids, phosphoric acids, derivatives of these and anhydrous derivatives.

Accordingly, the “other type organic acids” refer to all organic carboxylic acids, sulfinic acids, sulfonic acids, phosphoric acids, derivatives of these and anhydrous derivatives.

The “other type organic carbonyl analogue or analogues” refer to acetaldehyde, benzaldehyde, acetone, benzophenone, and diketone type molecules such as benzyl, dibenzoyl methane and phthalic anhydrite and molecules having 2 carbonyl groups, all molecules at least having aldehyde, ketone, ester and carbonate skeletons, such as ethyl acetate, alkyl benzoate and dimethyl carbonate, or include all molecules having a plurality of carbonyl groups selected from these substituent skeletons and analogues thereof.

“Inorganic substances” mean materials, specifically oxide materials, such as ash, clay, sand, and cluster and that like, consisting of typical and/or alkali and/or alkali-earth elements lighter than scandium.

The “heavy element” refers to a heavy element heavier than calcium in the periodic table. Examples of the heavy element species include all possible metallic or ionic or oxidized substances heavier than calcium in the periodic table, including transition metals, rare metals and typical elements, and mixtures of these. These heavy element species include ions, oxides and complexes bearing an arbitrary oxidation state, in metallic, alloy and/or particle form, and mixtures of these.

Oxidized number of “Heavy element species ions” is plus in heavy element species described above, and the “Heavy element species ions” also include all heavy metal derivatives, oxidized vanadium, Ni²⁺, Scandium, Cs, Iodide (I⁻, I³⁻), and examples thereof include Fe²⁺, Fe³⁺, Cu²⁺, Ge⁴⁺, Ti²⁺, As³⁺, Cr³⁺, etc.

“Organic solvent” means all kinds of organic liquid, including benzene, toluene, naphtha, acetone, ketone liquid, and additional liquid oil such as petroleum and crude oils with relatively low viscosity, or alcohol, ether, ester, and the other cost-effective solvents etc.

The “coexistence” refers to a state in which an organic phase substance and a water phase are in contact with each other, e.g., as shown in FIG. 3. The water phase refers to a moisture content collected together with the organic phase substance and also refers to water which is added later to the organic phase substance, and further refers to supplementally adding an organic phase substance and a water phase to the “coexistent” state. The “coexistence” is sometimes simply expressed as “accompanying a water phase” or “with accompanying water phase”. The “resultant of the coexistence” refers to a substance obtained by the coexistence.

The “contact” refers to the broadest concept used in the present invention for expressing the state of contacting chemical or chemicals with an organic phase substance. At this time, means such as mixing, stirring, bubbling and blowing are no object.

The “processing” refers to a broader concept, which represents separating/removing heavy element species, organic components and inorganic substances from organic phase substances, thereafter collecting heavy element species from the obtained water phase, and which further includes upgrading and reducing the weight of the organic phase substance refined by the aforementioned separation/removing step through a reaction. Note that “processing” is sometimes simply expressed as “method” or “process”.

The “separating/removing” refers to extracting and depositing heavy element species into a water phase, precipitating e.g., polymer organic components or inorganic substances in a water phase, as shown in FIG. 3. Note that the “separating/removing” is sometimes simply expressed as “removal” or “separation”. Of course, the “separating” also means to divide organic phase substance and water phase.

The “extracting” means that heavy element species contained in an organic phase substance migrate into a water phase through dissolution; in other words, that heavy element species are removed from an organic phase substance and allowed to dissolve in a water phase, as shown in FIG. 3. The “extracting” means that ions, oxides and complexes of heavy element species stabilized in the organic phase substance and bearing an arbitral oxidation state, which cannot be extracted by a general method extraction, migrate into a water phase through dissolution by carrying out the processing of the present invention.

The “depositing” means that heavy element species contained in an organic phase substance precipitate in a least soluble state and a solid state in a water phase when they migrate into a water phase or they are collected from a water phase or suspended or appear in a metal state or in a colloidal state, with the result that the heavy element species contained in an organic phase substance are induced and attracted into the water phase, as shown in FIG. 3.

The “precipitating” means that the organic phase substance coexists with the water phase and comes into contact with chemical or chemicals of the present invention, with the result that polymer organic components cause aggregation, becomes insoluble and sink and further means that inorganic substances sink, as shown in FIG. 3.

The “collecting” means that the heavy element species extracted and deposited into a water phase and/or asphaltene precipitated from an organic phase substance and/or inorganic substances are collected and taken, as shown in FIG. 3. Filtering is included in “collecting”. Other than this, for example, ion exchange or a reverse osmotic material or an adsorption material is used in collection. The filtering can be performed by using an arbitral filtering material such as alumina (aluminum oxide), silica gel (silicon oxide), sand, ceramic and a polymer. The “washing” is an auxiliary method for removing residual organic components in a water phase using organic solvents.

The “upgrading” means that organic components of an organic phase substance are converted into more beneficial, easier to handle materials and resources, and energy sources in order to use the organic phase substance as materials, resources, and energy sources, and also means that the purity of the heavy element species is increased, as shown in FIG. 3. The “upgrading” is sometimes called as “refining”.

Next, the outline of the present invention will be described. To solve the problems described in the background art of the invention, the following means for solving the problems is provided in the present invention.

Principally, to realize a reaction state in order to remove heavy element species from an organic phase substance in mild environmental conditions, a more reactive reagent is indispensable. To allow such a reagent to invade into an organic phase substance having a lower polarity than that of a water phase, the reagent should have a relatively lower dipole moment. As described, a first object of the present invention is to search and determine an appropriate chemical or chemicals having higher reactivity and relatively lower polarity.

A second object of the present invention is to provide a method for upgrading the organic phase substance using chemical or chemicals as mentioned above, more specifically, to provide a method for extracting and depositing heavy element species from the organic phase substance, and/or a method for precipitating asphaltene and inorganic substances and further a method for collecting them during the process for upgrading the organic phase substance.

A third object of the present invention is to obtain an organic phase substance refined by the method provided above and/or to collect the heavy element species extracted or deposited. The organic phase substance refined is further refined and used as mineral oil or as an organic phase substance or as a resource. The heavy element species collected often contain rare metals, etc. and are highly valuable as resources.

In the industry of oil or bitumen, a tremendous amount of resource is handled per day, and chemical or chemicals and solvents are discharged every day without being reused and recycled. This is a problem. Thus, it is extremely important to also reuse chemical or chemicals and solvents, for removing heavy element species from an organic phase substance. Accordingly, a fourth object of the present invention is to establish a processing method, apparatus, plant, etc. for enabling recycling of a whole or part of chemical or chemicals in order to remove and collect heavy element species from an organic phase substance.

As a result of continuous effort devoted in researches and investigations, in the fields to which the petroleum industry pertains, simple and effective processing methods for removing heavy element species from an organic phase substance, such as bitumen, tar or cokes, using at least halogen-containing chemical or chemicals accompanying a water phase or a mixture of at least oxygen-containing oxidizer or oxidizers and organic carbonyl analogue or analogues accompanying a water phase, which have never ever been used, in mild environmental conditions are provided to attain the aforementioned objects, as described below.

As shown in FIG. 3 which is a schematic view showing the outline of the present invention, the invention provides a processing method for upgrading organic phase substances by extracting, or depositing, or, in other words, removing, or separating heavy element species from the organic phase substance originating from resource substances in mild environmental conditions, accompanying with a water phase, using said halogen-containing chemical or chemicals and/or said mixture of oxygen-containing oxidizer or oxidizers and organic carboxylic analogue or analogues, and the other additional chemical or chemicals if necessary, and further provides a method for collecting removed heavy element species and a method for collecting other useful substances, further provides heavy element species, refined organic phase substance produced by using these methods, furthermore provides an apparatus, instrument and plant employing these processing methods, and additionally to provide means for recycling substances used in the processing methods, and the plant therefor.

More specifically, the invention is as follows:

(1)

A method for processing an organic phase substance, including: allowing an organic phase substance to coexist with a water phase, wherein the organic phase substance contains at least organic components originating from one or more selected from crude oil, bitumen, tar, residual fuel oil, petroleum residue, oil sands, tar-sand, asphaltene, fossil strata, cokes, oil-shale and coal; and contacting resultant of the above coexistence with halogen-containing chemical or chemicals, thereby extracting or depositing the heavy element species from the organic phase substance into the water phase. The “resultant of coexistence” means the organic phase substance coexisting with a water phase.

(2)

The method for processing an organic phase substance according to item (1), in which the halogen-containing chemical or chemicals include at least one or more chlorine-containing chemicals selected from chlorine gas, chlorofluorides or an interhalogen compound selected from bromine monochloride or iodine monochloride, a chlorine radial and a chlorine oxide.

The chlorine-containing chemical or chemicals, particularly, chlorine gas, has high reactivity and low polarity and basically its static dipole moment is 0, and thus, can be recycled using various types of reactions and can be further used in the industrial fields and is therefore suitable for attaining the aforementioned objects.

The chlorine-containing chemical or chemicals used in combination with a water phase were found to effectively serve for removing heavy element species from an organic phase substance in mild environmental conditions, which require no ultrahigh pressure and ultrahigh temperature conditions. Furthermore, combination use of chlorine-containing chemical or chemicals and a water phase contributes to improving safety in plants or industrials and easy-to-use of chemical or chemicals.

(3)

The method for processing an organic phase substance according to item (1), in which the halogen-containing chemical or chemicals at least include one or more bromine-containing chemical or chemicals selected from bromine gas, bromine liquid, bromine-containing interhalogen compounds, bromine radicals and bromine oxides.

(4)

The method for processing an organic phase substance according to item (1), in which the halogen-containing chemical or chemicals at least include one or more iodine-containing chemical or chemicals selected from iodine, sodium periodate, iodine oxides, iodine cations and iodine radicals.

The bromine-containing and iodine-containing chemical or chemicals set forth in items (3) and (4) have reactivity, which is not as high as those of chlorine-containing chemicals; however, these chemicals produce no precipitates and also usefully serve for removing and/or collecting the heavy element species contained in an organic phase substance. Oil processing is made easier by this. Accordingly, these are suitable for reducing the amount of precipitation and mass loss in the process.

(5)

A method for processing an organic phase substance, including allowing an organic phase substance to coexist with a water phase, wherein the organic phase substance contains at least organic components originating from one or more selected from crude oil, bitumen, tar, residual fuel oil, petroleum residue, oil sands, tar-sand, asphaltene, fossil strata, cokes, oil-shale and coal; and contacting resultant of the above coexistence with oxygen-containing oxidizer or oxidizers, and organic carbonyl analogue or analogues, thereby extracting or depositing the heavy element species into the water phase.

The “oxygen-containing oxidizer or oxidizers” consist of classes (i) and (ii). The class (i) includes oxidizer or oxidizers having an oxygen-oxygen bond excluding O₂, in other words, oxidizer or oxidizers having an oxygen-oxygen bond having relatively strong oxidizing ability such as peroxides and/or ozone and/or others; and the other class (ii) includes oxidizer or oxidizers other than the above.

Examples of the oxidizer or oxidizers (i) include hydrogen peroxide H₂O₂ and/or ozone O₃ and/or peroxycarboxylic acids RCO₃H such as meta-chloroperoxybenzoic acid, alkane peroxycarboxylic acid and other organic peroxycarboxylic acids and/or organic peroxides RO—OR, and/or ketone peroxides such as acetone peroxide

Examples of the oxidizer or oxidizers (ii) include chromic oxides such as chromic oxide (VI) CrO₃ and dichromic acid Cr₂O₇ and/or transition metal oxides such as osmium oxide OsO₄, and/or sulfur oxide compounds (SOₓ (x>2)), and/or 7,7,8,8-tetracyanoquinodimethane TCNQ derivatives having a strong electron attracting group, such as a cyano group and a nitro group.

The organic carbonyl analogue or analogues include organic derivatives having a carbonyl-type substituent having an oxygen-hetero atom double bond, such as organic carboxylic acids, sulfinic acids, sulfonic acids, phosphoric acids, derivatives of these and anhydrous derivatives.

Accordingly, the other type organic acids refer to all organic carboxylic acids, sulfinic acids, sulfonic acids, phosphoric acids, derivatives of these and anhydrous derivatives.

The other type organic carbonyl analogue or analogues refer to acetaldehyde, benzaldehyde, acetone, benzophenone, benzyl and diketone type molecules such as dibenzoyl methane and phthalic anhydrite and molecules having 2 carbonyl groups, all molecules at least having aldehyde, ketone, ester and carbonate skeletons, such as ethyl acetate, alkyl benzoate and dimethyl carbonate, or include all molecules having a plurality of carbonyl groups selected from these substituent skeletons and analogues thereof.

(6)

The method for processing an organic phase substance according to item (5), in which the oxygen-containing oxidizer or oxidizers include hydrogen peroxide and/or ozone.

The method is at least constituted of a step of contacting or mixing the organic phase substance with chemical or chemicals containing at least a mixture of hydrogen peroxide and organic carbonyl analogue or analogues selected from acetic acid and/or benzoic acid and/or a naphthalene acid derivative including monocarboxylic acid and oligocarboxylic acid derivative having an arbitrary substituent and/or maleic acid and/or naphthenic acid and/or organic acids other than those mentioned above, and/or carbonyl compounds other than those mentioned above. The reaction can proceed as a catalytic reaction, which is performed in the presence of excessive hydrogen peroxide and in the state where the amount of organic acid is extremely low. In the case of the mixture of hydrogen peroxide and an organic acid, no precipitation is observed after the reaction. Therefore, such a case is suitable for reducing the amount of precipitation and mass loss. The reaction having less effect upon an organic phase substance is realized after completion of the process.

To remove the heavy element species from the organic phase substance into a water phase, if required, an additional fresh batch of water is used. The additional fresh batch of water is useful to enhance the removing efficiency.

(7)

The method for processing an organic phase substance according to item (5) or (6), in which the organic carbonyl analogue or analogues include at least one or a mixture of two or more selected from acetic acid, benzoic acid, a naphthalene acid derivative, maleic acid, naphthenic acid, an organic acid and a carbonyl compound.

(8)

A method for processing an organic phase substance including

allowing an organic phase substance to coexist with a water phase, wherein the organic phase substance contains at least organic components originating from one or more selected from crude oil, bitumen, tar, residual fuel oil, petroleum residue, oil sands, tar-sand, asphaltene, fossil strata, cokes, oil-shale, and coal, and contacting resultant of the above coexistence with halogen-containing chemical or chemicals, oxygen-containing oxidizer or oxidizers and organic carbonyl analogue or analogues, thereby extracting or depositing the heavy element species into the water phase.

(9)

The method for processing an organic phase substance according to any one of items (1) to (8), in which the heavy element species include at least one or more elements selected from an element heavier than calcium, alloys containing the element, oxides, complexes or particles thereof.

(10)

The method for processing an organic phase substance according to any one of items (1) to (9), in which the contacting is performed at less than +100° C. and less than 10 atm.

These conditions are an example of the “mild environmental conditions” effective for removing heavy element species from an organic phase substance.

Particularly, the processing method is preferably performed at less than +30° C., i.e. near room temperature or less and near atmospheric pressure, i.e. about 1 atm. To realize the temperature of less than room temperature, water or a solution or a reaction mixture or an apparatus and an instrument and a plant is cooled during a process with ice or snow obtained at an actual factory site or near the site (FIG. 8, processing method [4]).

(11)

The method for processing an organic phase substance according to any one of items (1) to (10), in which, to the water phase, a nitrogen organic compound is added in a concentration of less than 15%.

As the nitrogen organic compound, triethyl amine or tributyl amine or ammonium derivatives of these, amine derivatives such as simple ammonium chloride or tetradodecyl ammonium halide and/or amide derivatives such as dimethyl formamide and other amide derivatives having a NH—CO peptide bond is/are added in a concentration of less than 15%.

(12)

The method for processing an organic phase substance according to item (11), in which the nitrogen organic compound is an amine derivative or an amide derivative.

(13)

The method for processing an organic phase substance according to any one of items (5) to (8), in which the organic carbonyl analogue or analogues are added to the water phase in a concentration of less than 30 wt %.

The processing method using the organic carbonyl analogue or analogues is a processing method for removing and/or collecting heavy element species, which are constituted of ions and/or complexes and/or oxides and/or particles of any heavy element selected from a typical element heavier than calcium and transition metals, or alloys thereof, and which are contained in an organic phase substance consisting of a mixture containing at least organic components originated from crude oil, bitumen, tar, residual fuel oil, petroleum residue, oil sands, tar-sand, asphaltene, fossil strata, cokes, oil-shale and coal, and accompany a water phase; a processing method for extracting or depositing heavy element species, which is at least constituted of a step of contacting or mixing the organic phase substance with chemical or chemicals containing at least a mixture of oxygen-containing oxidizer or oxidizers and organic carbonyl analogue or analogues selected from acetic acid and/or benzoic acid and/or a naphthalene acid derivative and/or maleic acid and/or naphthenic acid and/or organic acids other than those mentioned above, and/or carbonyl compounds other than those mentioned above and at least constituted of a step of removing the heavy element species from the organic phase substance to a water phase, after the organic phase substance is contacted or mixed with the mixture, and/or a step of collecting the heavy element species from the water phase after the organic phase substance is contacted or mixed with the mixture.

The organic carbonyl analogue or analogues include organic derivatives having a carbonyl group, such as organic carboxylic acids, sulfinic acids, sulfonic acids, phosphoric acids, derivatives of these, and anhydrous acid derivatives. Accordingly, the other type organic acids refer to all organic carboxylic acids, sulfinic acids, sulfonic acids, phosphoric acids, derivatives of these and anhydrous acid derivatives. The other type organic carbonyl analogue or analogues refer to all organic molecules having aldehyde, ketone, ester, and carbonate skeletons, including acetaldehyde, benzaldehyde, acetone, benzophenone, diketone such as benzyl, dibenzoyl methane, and other molecules having 2 carbonyl groups, ethyl acetate, alkyl benzoate, and dimethyl carbonate, or all molecules having 2 or more carbonyl groups selected from these skeletons

(14)

The method for processing an organic phase substance according to any one of items (1) to (13), in which the halogen-containing chemical or chemicals are obtained by electrolysis of an aqueous solution, the aqueous solution at an anode electrode side is a water phase containing at least alkali metal halide and/or an alkaline-earth metal halide.

(15)

The method for processing an organic phase substance according to item (14), in which the water phase containing the alkali metal halide and/or the alkaline-earth metal halide is prepared from one or more water sources selected from warm water used for softening the organic phase substance, a river, a lake, a pond, sea water, city water in actual factory site and water prepared by soaking soil in water.

(16)

The method for processing an organic phase substance according to item (14) or (15), in which the halogen-containing chemical or chemicals include an aqueous solution on an anode side after electrolysis.

(17)

Halogen-containing chemical or chemicals obtained by the method for processing an organic phase substance according to any one of items (14) to (16).

(18)

A refined organic phase substance processed and produced by the method for processing an organic phase substance according to any one of items (1) to (16).

(19)

Heavy element species collected from a water phase processed by the method for processing an organic phase substance according to any one of items (1) to (16).

The heavy element species extracted and deposited into a water phase can be collected by filtering. Other than this, for example, an ion exchange or reverse osmosis material or an adsorption material can be used for collection. The filtering can be performed using any filtering material such as alumina (aluminum oxide), silica gel (silicon oxide), sand, ceramic and a polymer. Washing is an auxiliary method for removing residual organic components in a water phase using organic solvents.

(20)

The heavy element species according to item (19), in which

the collection is performed by depositing heavy element species as heavy element species or alloys using a plating technique or a reductive reaction.
(21)

The method for processing an organic phase substance according to any one of items (1), (2) and (14) to (16), in which

the organic phase substance is contacted with chlorine-containing chemical or chemicals, as the halogen-containing chemical or chemicals, including at least one or a mixture of two or more selected from chlorine gas, an interhalogen compound selected from chlorofluorides or bromine monochloride or iodine monochloride, a chlorine radial and a chlorine oxide; and organic components of asphaltene and/or inorganic substances are collected from the resulting precipitate.
(22)

A plant for processing an organic phase substance using the method for processing an organic phase substance according to any one of items (1) to (18) and (21).

The “plant” is used for meaning an apparatus, equipment and instrument constituting the plant and also includes a more complicated apparatus and factory constituted of these.

(23)

The plant according to item (22), in which a pipe for transferring chemical or chemicals containing one or more selected from the halogen-containing chemical or chemicals, the oxygen-containing oxidizer or oxidizers, the organic carbonyl analogue or analogues, hydroxide anions and the nitrogen organic compounds is a double cylinder consisting of an external cylinder and an internal cylinder arranged within the external cylinder and the chemical or the chemicals are transferred through the internal cylinder.

(24)

The plant according to item (22), in which, when the organic phase substance according to any one of items (2) to (4) is processed using the halogen-containing chemical or chemicals, which are electrolytically obtained from the aqueous solution according to any one of items (14) to (16), on an anode electrode side, by using hydrogen gas and/or hydroxide anions electrolytically obtained on the cathode electrode side;

an acidic water phase, which is generated when the halogen-containing chemical or chemicals according any one of to items (2) to (4) is contacted with the organic phase substance accompanying a water phase, is neutralized; or

a hydrodesulphurization reaction, a hydrodenitrogenation reaction or a hydrodehalogenation reaction is performed in the presence of a transition metal catalyst; and

further, if necessary, an alcohol is added or an alcohol is added in place of hydrogen gas and a hydrodesulphurization reaction, a hydrodenitrogenation reaction or a hydrodehalogenation reaction is performed in the presence of a transition metal catalyst.

The hydrodehalogenation reaction refers to a hydro-defluorination reaction, dechlorination reaction, debromination reaction and deiodine reaction. Examples of the transition metal catalyst include iron, palladium, rhodium, iridium, platinum and molybdenum. This processing method realizes recycling of chemical or chemicals and substances, and a reaction less affecting an organic phase substance in the process of the present invention.

(25)

A plant for processing an organic phase substance using the method for processing an organic phase substance according to any one of items (14) to (16), having

a line for using hydroxide anions, which are generated on a cathode side when the halogen-containing chemical or chemicals are electrolytically produced, in a neutralization reaction of the water phase performed after the organic phase substance is processed, or

a line for using the hydroxide anions or hydrogen generated on the cathode side, in a hydrodesulphurization reaction or a hydrodenitrogenation reaction or a hydrodehalogenation reaction of the organic phase substance in the presence of a transition metal catalyst, or

a line for adding an alcohol in place of the hydrogen.

(26)

To the members in the plant according to items (23) to (25), chemical-resistant coating is applied. For example, halogen-containing chemical or chemicals produce a corrosive acid such as hydrochloric acid or the analogues thereof, when they react with water and thus coating is needed. The instrument, apparatus and plant for extracting or depositing and/or collecting the heavy element species have structural members such as pipes, tanks and/or trenches using materials having a resistance to halogen, acid or alkali, such as Teflon (registered trade mark), glass, organic chloride, polyvinyl chloride (PVC) or carbon-related coating.

(27)

For example, the plants of the invention are constituted of the following structures.

A plant for use in the processing method according to any one of items (1) to (16) and (21), including:

a whole system; a processing plant for removing and/or collecting the heavy element species, equipped with a safety system selected from the following blocks A to D:

Block A; an apparatus for detecting chemical or chemicals, that is, a sensor and/or a sensing device and/or a sensing control room for checking leakage of gas in the atmosphere or heavy element species in water or soil or other contaminants, as shown in FIGS. 14 to 18,

Block B; a pipe having a double-wall structure, a wall or a net or a storage, or a plant or a factory covered with a dome for preventing leakage of a gas or heavy element species or other contaminants, as shown in FIGS. 14 to 18,

Block C; a closed structure using water and explosion avoidance structure, equipped with an injection system or spray system for nitrogen gas for preventing oxidative explosion of a gas, or a weak alkali and/or a reducing agent for neutralizing hazardous acid or halogen gas, as shown in FIGS. 14 to 18, and

Block D; a storage tank or a reservoir for handling the substances and chemical or chemicals according to item (27), in view of safety and environmental concern.

For example, pipe structures are shown in FIGS. 14 to 18, which basically has a wall or net or factory surrounding processing plants including apparatuses and instruments and plants, and sensors and control room for use in checking chlorine gas (e.g., sensor 1) and hydrogen gas (e.g., sensor 2) inside and/or outside the pipe of the double-wall structure. If something leaks or a dangerous situation happens, nitrogen gas and/or solutions of weak alkali and/or reducing reagents for use in neutralization are injected or sprayed into the pipes, and/or into the inside wall or net or the factory. The resultant solution is temporarily collected in the storage site such as a tank or a reservoir for safety.

In the control room or check place for safety, protective clothing, full-face masks and gloves, electric power backup systems and manual modes requiring no electric power, e.g., a color change detection system using a telescope in combination with a manual valve for operating opening/closing from outside the wall should be stored. This kind of safety system can be installed and stored in all plants according to the present invention.

In the present invention, as to how to contact or mix chemical or chemicals with an organic phase substance, any kinds of procedures and constitutions can be employed.

For example, FIG. 14 shows a structure of a pipe and apparatus for removing heavy element species from a liquid-state organic phase substance. The spray system is used in combination with a mixer for enhancing mixing efficiency.

FIG. 15 shows a structure of a pipe and apparatus for directly mixing a liquid-state organic phase substance with chemical or chemicals using a mixer in an initial step. In this case, the chemical or chemicals are directly injected into the liquid phase of the organic phase substance.

FIG. 16 shows a structure of a pipe and apparatus for removing heavy element species from a liquid-state organic phase substance by using a two-phase system in combination with a mixer. In this case, chemical or chemicals are injected into one of the two phases consisting of the liquid-state organic phase substance and a water phase. The procedure how to inject the chemical or the chemicals should be selected by the plant's users.

FIG. 17 shows a structure of a pipe and apparatus for removing heavy element species from a solid-state organic phase substance. In this case, the ground solid phase of the organic phase substance is mixed with a water phase containing chemical or chemicals by a mixer.

FIG. 18 shows a structure of a pipe and apparatus for removing heavy element species from a solid-state organic phase substance by a mixer. In this case, the ground solid phase of an organic phase substance is mostly arranged at the bottom of a trench and the water phase is recycled in the system to enhance the removal efficiency.

(28)

The plant as shown in the diagram of FIG. 6 is used for a processing method according to any one of items (1) to (16) and (21), at least having,

Block F; an apparatus equipped with pipes or trenches and a mixer to add naphtha, petroleum, crude oil, water, and/or other solvents and/or additives selected from alkali metal ions and/or alkali earth metal ions, nitrogen-organic compounds and/or organic carbonyl analogue or analogues to a liquid-state organic phase substance,

Block J; a plant for removing heavy element species by contacting or mixing one or a mixture of two or more chemicals selected from the chemical or the chemicals described in any one of items (1) to (16) with a liquid-state organic phase substance accompanying water phase,

Block K; a plant to basically separate an organic phase substance and a water phase, from a reaction mixture after the s are contacted or mixed with the organic phase substance, and/or a plant to possibly separate organic components of asphaltene and/or inorganic substances, and

A facility or apparatus or plant from which the finally obtained heavy element species and refined organic phase substance are sent to a next step, as a resource or substance or for storing them.

The plant of the invention is complemented and expanded by the following description and Examples; however, the concept of invention described in the specification is not limited by the following description and Examples. Other methods and procedures or the methods and procedures modified or rearranged within the concept of the present invention described in the specification are all included in the invention set forth in the claims of the invention.

For example, a plant as shown in the diagram of FIG. 7 is used for a processing method set forth in any one of items (1) to (16) and (21), having:

Block E; an apparatus equipped with pipes or trenches to transfer a mixture of the organic phase substance and warm water after warm water is injected in order to soften and mine oil sands,

Block F; an apparatus equipped with pipes or trenches and a mixer to add naphtha, petroleum, crude oil, water, and/or other solvents and/or additives selected from alkali metal ions and/or alkali earth metal ions, nitrogen-organic compounds and/or organic carbonyl analogue or analogues to a liquid-state organic phase substance,

Block G; an apparatus to separate an organic phase substance from a water phase,

Block H; an apparatus to cool the mixture,

Block I; an electrochemical apparatus to produce chlorine-containing species, in a water phase using an arbitral aqueous solution including the solution obtained after warm water is injected to soften oil sands and tar, or a solution prepared from a river or lake or pond or sea water or having at least an alkali metal chloride and/or an alkali earth metal chloride added thereto, and produced from the solution after the warm water is separated from a mixture of bitumen and the warm water or after a hydrodehalogenation reaction, wherein said solution can be a suspension containing insoluble materials or a gas-bubbles-containing solution,

to produce hydrogen gas, which is used for hydrodehalogenation in Block O in item (28) or in other processes,

to produce hydroxide anions (alkali), which are used in item (28) or in other processes,

Block J; a plant to remove heavy element species by contacting or mixing one or a mixture of two or more chemicals selected from the chemical or the chemicals set forth in any one of items (1) to (16) with the liquid-state organic phase substance accompanying a water phase,

Block K; a plant to separate essentially an organic phase substance and a water phase, and/or possibly organic components of asphaltene and/or inorganic substances from the reaction mixture after the chemical or the chemicals are contacted or mixed with the organic phase substance,

Block L; a plant to add and mix an additional fresh batch of water originating from an arbitral aqueous solution, such as the solution after warm water is injected to soften oil sands and tar in order to re-extract heavy element species or a solution prepared from a river or lake or pond or sea water of an actual industrial land, to the organic phase substance separated after the reaction,

The additional fresh batch of water is used as needed to remove the heavy element species from the organic phase substance into a water phase and useful to enhance the efficiency of removal.

Block M; a plant to recycle whole or partial organic solvents and a water phase used in all processing plants,

Block N; a plant to collect heavy element species such as vanadium oxide species and nickel ions from a water phase through precipitation and/or dissolution and/or crystallization and/or washing and/or adsorption and/or filtering using sand or oxide powder or a material using a polymer such as ion exchange resins and a reverse osmosis membrane, or

to collect heavy element species or alloys by plating techniques from the water phase,

Block O; a plant for performing hydrodehalogenation after heavy element species are removed from the organic phase substance including bitumen or tar, and which consists of a first reactor for hydrodehalogenation using the alkali and hydrogen gas or the alcohol and the transition metal catalysts first used, and next, a water-addition system (secondary extraction) to extract salts including alkali metal chloride and/or alkali earth metal chloride,

Block P; a plant to transfer the extracted salts including an alkali metal chloride and/or an alkali earth metal chloride back to the electrochemical instruments, and

Block Q; an apparatus equipped with pipes or trenches and a mixer to neutralize acidic water in the whole system set forth in (28) and/or to perform a reaction in the first reactor in Block O by using hydroxide anions (alkali) electrolytically generated.

Finally, obtained heavy element species and refined organic phase substance are sent as a resource or a substance for a next step or stored.

(29)

A plant shown in the diagram of FIG. 9 is used for a processing method set forth in any one of items (1) to (16) and (21), at least including,

Block R; an instrument to grind a solid-state organic phase substance including cokes or oil-shale or coal to prepare powders, shots, lump, or pieces, which are transferred by an apparatus such as pipes or trenches or belt conveyors,

Block U; a plant to remove heavy element species by contacting or mixing one or a mixture of two or more chemicals selected from the chemical or the chemicals set forth in any one of items (1) to (16) with the solid-state organic phase substance accompanying water phase,

Block V; a plant to separate or filter the powders, shots, lump, or pieces from the water phase after contacting or mixing with the chemical or the chemicals, and

an instrument, apparatus or plant to feed the finally obtained heavy element species to a next step as a resource or a substance, and to store or convert the reacted organic phase substance as a resource or a substance.

The plant of the invention is complemented and expanded by the following description and Examples; however, the concept of invention described in the specification is not limited by the following description and Examples. Other methods and procedures or the methods and procedures modified or rearranged within the concept of the present invention described in the specification are all included in the invention set forth in the claims of the invention.

For example, a plant shown in the diagram of FIG. 10 is used for a processing method set forth in any one of items (1) to (16) and (21), having

Block R; an apparatus to grind cokes or oil-shale or coal to prepare powders, shots, lump, or pieces to be transferred by an apparatus such as pipes or trenches or belt conveyors,

Block S; an electrochemical apparatus to produce the halogen-containing chemical or chemicals set forth in any one of items (1) to (5) or a mixture of two or more chemicals selected in any one of items (1) to (8), in a water phase, using an arbitral aqueous solution including the solution obtained after warm water is injected to soften oil sands and tar, or a solution prepared from a river or lake or pond or sea water or having at least an alkali metal chloride and/or an alkali earth metal chloride added thereto, and the solution obtained after the warm water is separated from a mixture of bitumen and the warm water or after a hydrodehalogenation reaction,

to produce hydrogen gas, which is used in other processes, and

to produce hydroxide anions (alkali), which are used in item (29) or in other processes and Block Z

Block T; an apparatus equipped with pipes or trenches and a mixer to prepare and/or transfer a solution prepared from water and/or a river or lake or pond or sea water or having at least an alkali metal chloride and/or an alkali earth metal chloride added thereto, and obtained from the solution after the warm water is separated from a mixture of bitumen and the warm water or after a hydrodehalogenation reaction,

Block U; a plant to remove heavy element species by contacting or mixing the halogen-containing species with the powders, shots, lump, or pieces using a water phase obtained from an arbitral aqueous solution, including the solution obtained after warm water is injected to soften oil sands and tar, or a solution prepared from a river or lake or pond or sea water,

Block V; a plant to separate or filter the powders, shots, lump or pieces from the water phase after contacting or mixing the halogen-containing species, and to transfer the filtrate separated or filtered to a next step, and to stock the powders, shots, lump, or pieces separated or filtered,

Block W; a plant to recycle all or partial water phase used in all processing plants,

Block X; a plant to collect heavy element species such as vanadium oxide species and nickel ions from the water phase after separation or filtering, through precipitation and/or dissolution and/or crystallization and/or washing and/or adsorption and/or filtering using sand or oxide powder or a material using a polymer such as ion exchange resins and a reverse osmosis membrane,

or to collect heavy element species or alloys by plating techniques from the water phase,

Block Y; a plant for upgrading heavy element species from the collected mixture after processing, first upgrading or recrystallizing each heavy element species and then dissolving refined heavy element species including alloys, plating, washing, or reacting to obtain the corresponding upgraded heavy element species or alloys,

Block Z; an apparatus equipped with pipes or trenches and a mixer to neutralize acidic water and/or the powders, shots, lump or pieces in the whole system set forth in item (29) after separation or filtering is performed by using hydroxide anions (alkali) electrolytically generated.

Finally, the obtained heavy element species are sent to a next step as a resource or a substance and the reacted organic phase substance is stored or transferred to be used as a resource.

FIG. 12, in which FIGS. 6 to 11 of the present invention is combined, is a conceptual image for removing and/or collecting the heavy element species from an organic solid phase. For example, parallel processing lines, which have filtering materials such as sands consisting of silicon oxide and/or aluminum oxide, or organic polymers or ceramics which comprise reverse osmosis membrane or system (ROM, black rectangle parts in FIG. 12) or a roll system comprising filtering materials such as organic polymers (e.g., roll-to-roll structures in FIG. 12) are utilized to collect heavy element species and other chemical or chemicals and salts. These blocks can be connected in various ways (multiple step connection, circulation connection, parallel connection), as shown in FIG. 13. Better quality or other usage of resources from an organic phase substance, and valuable heavy element species are produced and sent to a next step by using the present invention. As shown in FIG. 12, the water phase and the organic phase substance are contacted with each other. If stirred vigorously, they are mixed to obtain an emulsion-like mixture. If stirred gently, the water phase (lower) and the organic phase substance (upper) are contacted with each other while keeping two discrete phases. The water phase is circulated through a water-phase circulation line. Water insoluble content (deposit, precipitate) and heavy element species (extracted substance) dissolved in water are continuously collected by a separation apparatus such as ROM.

(30)

A plant to which the processing method set forth in any one of items (22) to (25) is to be applied, constituted of an apparatus, instrument and/or plant which are connected to form a multiple-stage and/or circulative and/or parallel system (line) as a whole system.

FIG. 13 illustrates a general concept of multiple and/or circulative and/or parallel lines in the processing method. The processing method [22] includes multiple and circulative lines which enhance removal and collection efficiency of heavy element species. The processing method [23] includes parallel lines which enhance throughput (amount of substance to be processed) of heavy element species and maintenance performance of the processing plant. For example, the parallel line, as shown by black gray rectangle in FIG. 12, heavy element species and other chemical or chemicals and salts are collected.

### Advantageous Effects of Invention

The present invention, owing to the aforementioned constitutions, even if an organic phase substance is processed in milder environmental conditions than those of conventional methods, heavy element species, other inorganic substances and organic components can be extracted and deposited from an organic phase substance into the accompanying water phase, thereby removing them. Furthermore, chemical or chemicals used in reactions and the water phase can be recycled. Because of this, the invention is economic and can reduce environmental loads. Furthermore, a highly safe apparatus and plant can be provided.

### BRIEF DESCRIPTION OF DRAWINGS

FIG. 1 shows a facile experimental set-up for extracting or depositing and collecting heavy element species using organic phase substance of solution originating from vanadyl (IV) meso-tetraphenyl porphine as a simple model organic components in toluene.

FIG. 2 shows an experimental set-up for extracting or depositing and collecting heavy element species using organic phase substance of solution originating from bitumen, tar, or oil sands in organic solvent.

FIG. 3 The figure is a schematic view showing the outline of the present invention.

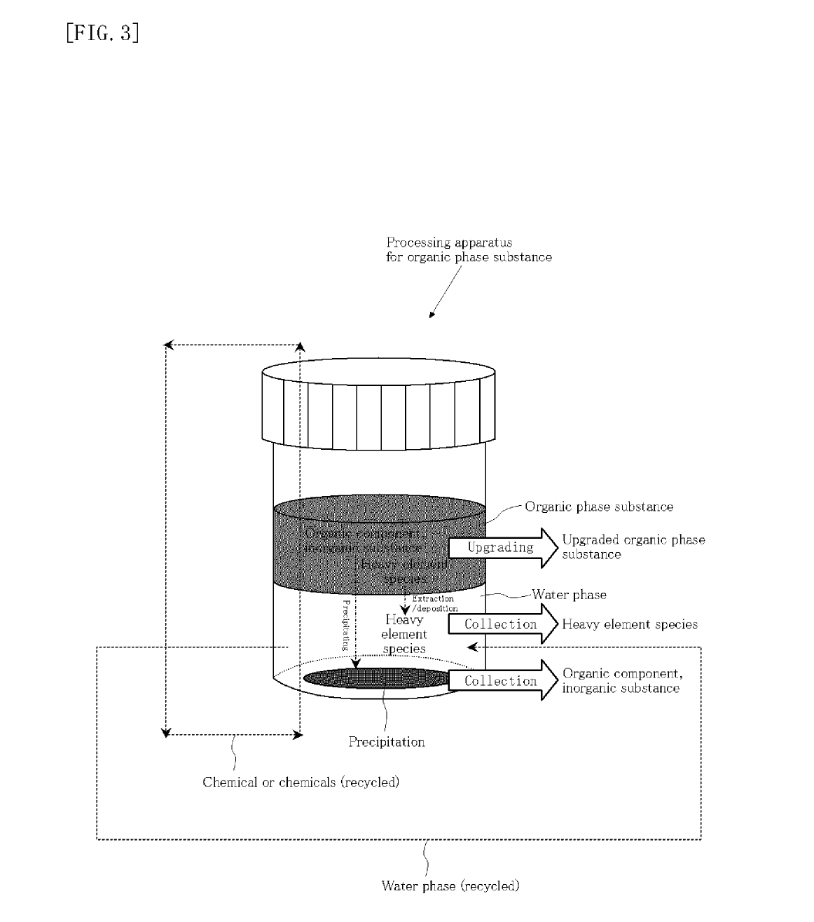

FIG. 4 The figure is a scale-up experimental set-up for collecting heavy element species by extracting or depositing them using a mechanical stirrer. Each number 1-12 in FIG. 4 shows; 1: organic phase substance, 2: water phase, 3: chemical (chlorine gas in this case) injection, 4: mechanical stirrer, 5: cooling or heating system (ice water in this case), 6: exit of cooling or heating system, 7: reaction pot (sodium hypochlorite in this case), 8: dropping funnel (hydrochloric acid in this case), 9: dry nitrogen injection, 10: thermometer, 11: a trap of exhausted gas, 12: three-neck glass vessel (flask).

FIG. 5 The figure shows the results of Embodiments 8 to 11.

FIG. 6 shows an essential block diagram in the present invention illustrating one embodiment of the process for extraction or deposition and collection of heavy element species from organic phase substance, which is liquid.

FIG. 7 shows a block diagram illustrating one embodiment of the process for extraction or deposition and collection of heavy element species from organic phase substance, which is liquid.

FIG. 8 shows a developed processing plant including apparatus and instruments equipped with pipes or trenches or transfer system etc. for extracting or depositing and/or collecting said heavy element species from organic phase substance, which is liquid, e.g., bitumen, tar, asphaltene, and/or petroleum residue.

FIG. 9 shows an essential block diagram in the present invention illustrating one embodiment of the process for extraction or deposition and collection of heavy element species from organic phase substance, which is solid.

FIG. 10 shows a block diagram in the present invention illustrating one embodiment of the process for extraction or deposition and collection of heavy element species from organic phase substance, which is solid.

FIG. 11 shows a developed processing plant including apparatus and instruments equipped with pipes or trenches or transfer system etc. for removing and/or collecting said heavy element species from organic phase substance, which is solid, e.g., cokes, oil-shale, and/or coal.

FIG. 12 shows a conceptual image for extracting or depositing and/or collecting said heavy element species from organic phase substance.

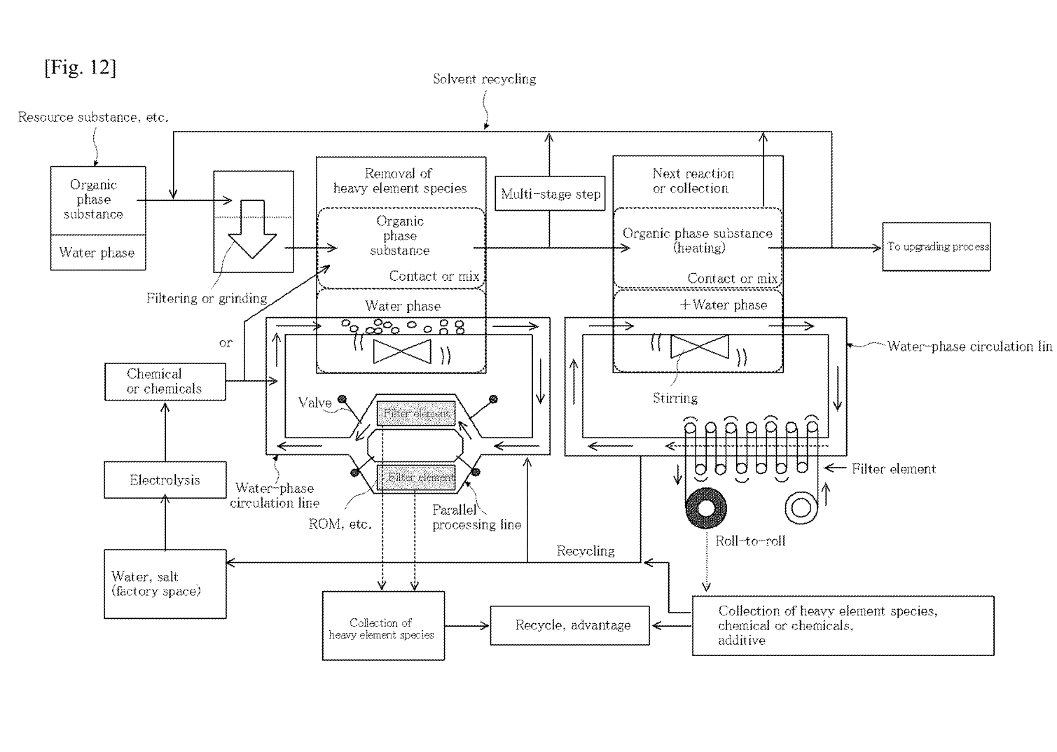

FIG. 13 shows the general concept of multiple and/or cyclic and/or parallel lines in the process method in the present invention.

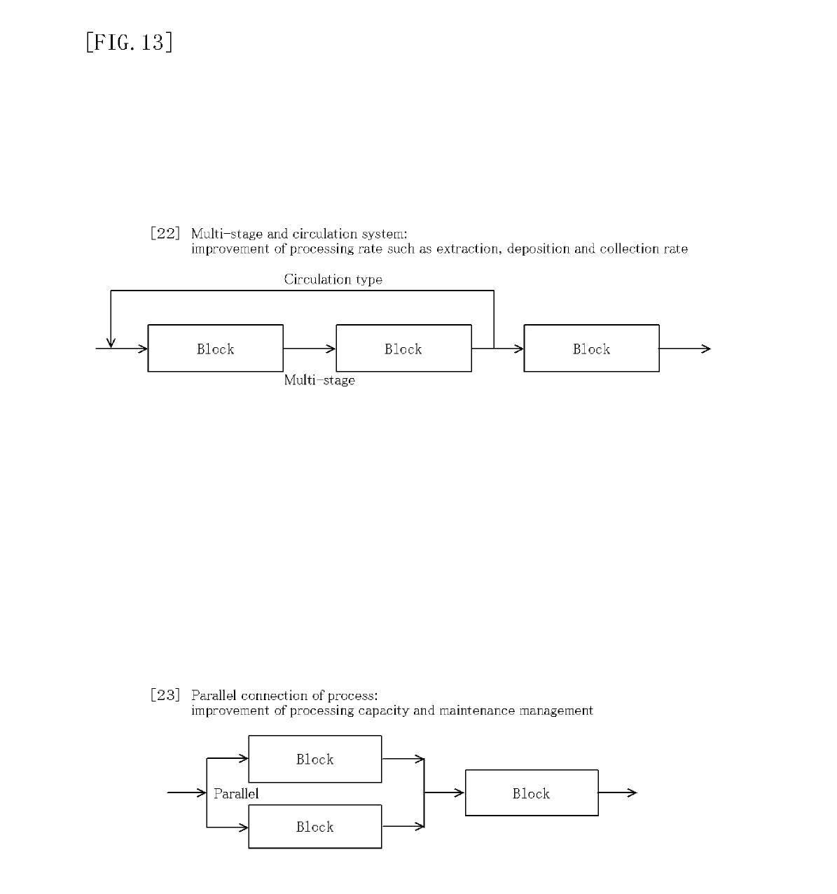

FIG. 14 shows a structure of pipe and apparatus for extracting or depositing heavy element species from organic phase substance, which is liquid, using spray system.

FIG. 15 shows a structure of pipe and apparatus for directly mixing organic phase substance, which is liquid, with chemical or chemicals in an initial step.

FIG. 16 shows a structure of pipe and apparatus for extracting or depositing heavy element species from organic phase substance, which is liquid, using two phase system.

FIG. 17 shows a structure of pipe and apparatus for extracting or depositing heavy element species from organic phase substance, which is solid.

FIG. 18 shows a structure of pipe and apparatus for extracting or depositing heavy element species from organic phase substance, which is solid, using recycle system of water phase.

### DESCRIPTION OF EMBODIMENTS

Embodiments of the invention will be more specifically described with reference to the accompanying drawings.

The invention is exemplified by the following description and examples, however, the concept of invention presented here is not limited by the description and examples following below. The other methods and procedures, or changed, rearranged, or supplemented methods and procedures within the concept of the invention presented here, are all included in the invention claimed in the present invention.

The changes of heavy element species concentration, especially vanadium concentration in organic phase substance are estimated by (A) UV-Vis absorption spectra change at around 410 nm corresponding to the absorption of porphine derivatives, (B) X-ray photoelectron spectroscopy (XPS) core level spectra, V 2p in the case of vanadium, and (C) secondary ion mass spectroscopy (SIMS) of each element, at 50.945 in the case of vanadium, under the same sample preparation procedure.

The changes of heavy element species concentration, especially vanadium concentration in water phase are also measured by (a) XPS core level spectra, V2p in the case of vanadium, and (b) SIMS of each element, at 50.945 in the case of vanadium, under the same sample preparation procedure.

All changes of heavy element species concentration are evaluated based on standard curves for each spectroscopy using standard sample solutions of vanadyl (IV) meso-tetraphenyl porphine in toluene as an organic phase substance, and standard sample solutions of vanadium(IV) oxide sulfate hydrate in water phase, with concentration in the range of 0.1-1000 ppm.

In the embodiments, all methods and processes were performed in mild environmental conditions, more specifically, unless otherwise specified, performed in a closed or covered container at a temperature of less than +100° C. and a pressure of less than 10 atm., particularly, at room temperature within the range of +20 to 23° C. and atmospheric pressure of about 1 atm. All processing methods were tested within a draft chamber equipped with a chlorine gas sensor from a safety point of view.

### Embodiment 1

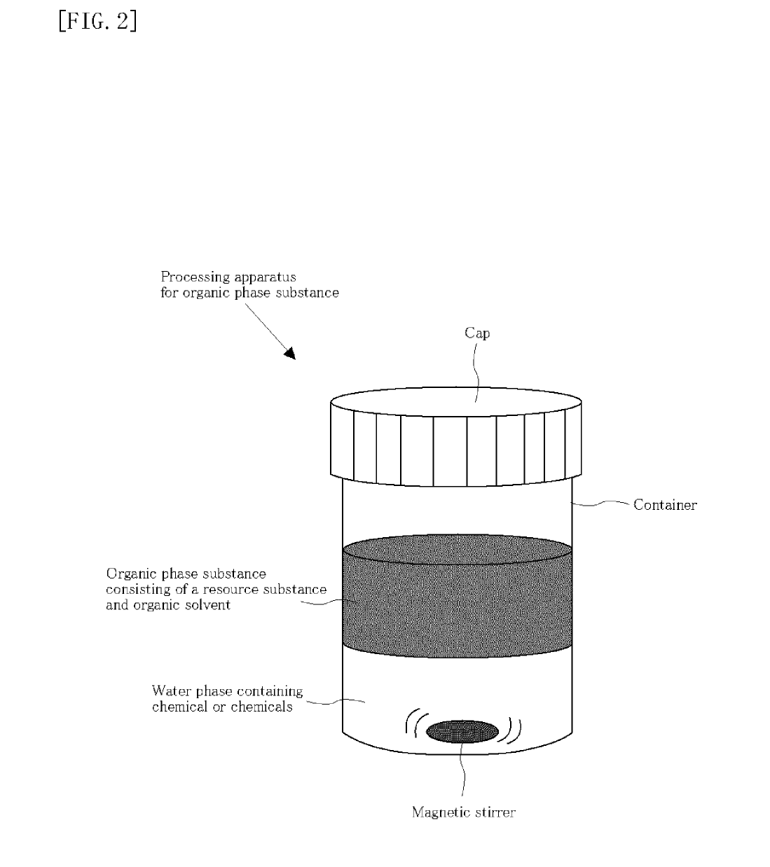

An experimental set-up is illustrated in FIG. 2. To a 6 mL organic phase substance of solution originating from bitumen produced in Alberta, Canada in toluene/petroleum ether (1/2) with a vanadium concentration of ca. 2 ppm, which is filtered by cellulose (advantec No. 5B), is mixed ca. 10 mL of chlorine gas in air by syringe bubbling three times and stirred about 20 min. The small amount of precipitate is collected by alumina filtering, however, no significant signals of vanadium are observed by UV-Vis, XPS, and SIMS in the precipitation, and heavy element species including vanadium remained in organic phase substance.

On the other hand, to an organic phase substance solution (6 mL), which is originating from bitumen produced in Alberta, Canada dissolved in toluene/petroleum (1/2) having a vanadium concentration of about 2 ppm and filtered by cellulose (advantec No. 5B), accompanying water (milliQ water 5.9 mL having 0.1 mL of dimethylformamide (DMF) added thereto), more specifically, to the water phase of the two-phase solution consisting of the organic phase substance and the water phase, chlorine gas (about 10 mL in the air) is added by repeating bubbling three times by a syringe. The mixture is stirred about 20 min. The obtained organic phase substance and water phase (two-phase solution) are separated by an extraction funnel and analyzed by UV-Vis, XPS, and SIMS. As a result, it was found that vanadium was significantly removed from the organic phase substance into the water phase. More specifically, it was found that a reduction of vanadium concentration in the organic phase substance is about −43%. An appropriate amount of vanadium oxide is crystallized or solidified and collected from a water phase by vaporizing water.

As described above, by allowing an organic phase substance to coexist with a water phase and contacting a halogen-containing chemical or chemicals, i.e., a chlorine-containing chemical or chemicals with the organic phase substance and processing the reaction system, it is possible to extract or deposit one of the heavy element species, vanadium, from the organic phase substance into the water phase. Other than vanadium, iron, nickel, copper, chromium, titanium, arsenic, etc. can be extracted.

These results reveal that the processing method for removing and collecting one of heavy element species, vanadium oxide, from an organic phase substance by using chlorine gas as a chlorine-containing chemical or chemicals accompanying a water phase is sufficiently performed in mild environmental conditions, i.e., a temperature of less than 30° C. and atmospheric pressure of about 1 atm.

### Embodiment 2

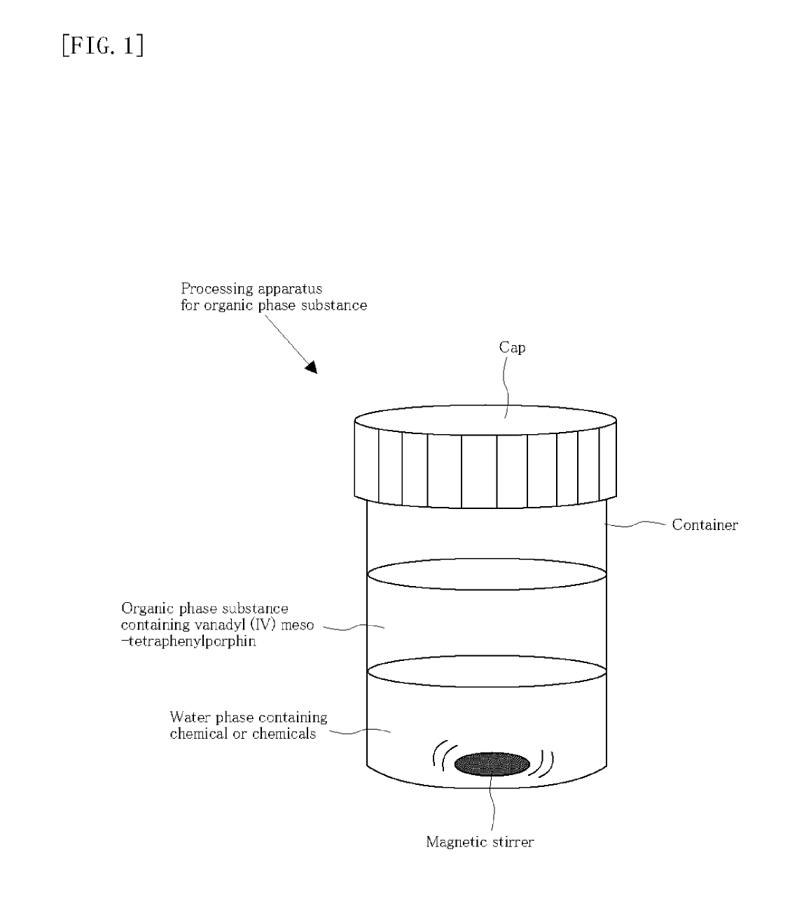

A facile experimental set-up is illustrated in FIG. 1 as following below when used porphine compounds. A 2 mL of a solution of an organic phase substance originating from vanadyl (IV) meso-tetraphenylporphin, which is used as a simple model of organic components of porphyrin in toluene having a concentration of about 107 ppm, is subjected accompanying with pure water (milliQ) of 1.5 mL including 5.25% sodium hypochlorite as one of oxidized chlorine species, and dimethylformamide (DMF) (0.1 mL) as one of nitrogen-organic compounds.

To the obtained two-phase solution, if 0.3 mL of concentrated hydrochloric acid (30%) is added while stirring by a magnetic stirrer, chlorine gas is generated on site. The color of vanadyl (IV) meso-tetraphenylporphin disappeared within 4 minutes. The obtained organic phase substance and water phase were separated by an extraction funnel and analyzed by UV-Vis, XPS and SIMS. As a result, it was found that vanadium was significantly removed from the organic phase substance into a water phase.

More specifically, it was found that a reduction of vanadium concentration in the organic phase substance is about −98%. An appropriate amount of vanadium oxide is crystallized or solidified and collected from a water phase by vaporizing water. The results showed the efficiency of chlorine-containing chemical or chemicals accompanying water phase and the efficiency of addition of a nitrogen organic compound, i.e., dimethylformamide (DMF).

As described above, by contacting a halogen-containing chemical or chemicals, i.e., a chlorine-containing chemical or chemicals, with an organic phase substance in a system where an organic phase substance is allowed to coexist with a water phase, and processing it, a heavy element species, vanadium, can be extracted or deposited from the organic phase substance into the water phase.

### Embodiment 3

A 3 mL organic phase substance of solution originating from vanadyl (IV) meso-tetraphenyl porphine as a simple model organic components (non patent literatures 1 and 2) about 120 ppm is subjected accompanying with pure water (milliQ) of 2 mL including 5.25% sodium hypochlorite as one of oxidized chlorine species.

Acetic acid of 0.2 mL is added to the obtained two phase solution stirring with magnetic stirrer, which leads to partially production of chlorine gas and/or the other reactive oxidized chlorine species such as hydrogen hypochlorite in situ. The color of vanadyl (IV) meso-tetraphenyl porphine disappeared within 10 min. The obtained organic phase substance and water phase are separated by extraction funnel and analyzed by UV-Vis, XPS, and SIMS to find significant removal of vanadium from material to water phase.

More specifically, it was found that a reduction of vanadium concentration in the organic phase substance is over −68%. An appropriate amount of vanadium oxide is crystallized or solidified and collected from a water phase by vaporizing water.

As described above, by contacting a halogen-containing chemical or chemicals, i.e., a chlorine-containing chemical or chemicals, with an organic phase substance in a system where an organic phase substance is allowed to coexist with a water phase, and processing it, a heavy element species, vanadium, can be extracted or deposited from the organic phase substance into the water phase.

### Embodiment 4

A 3 mL organic phase substance of solution originating from vanadyl (IV) meso-tetraphenyl porphine as a simple model organic components (non patent literatures 1 and 2) about 120 ppm is subjected accompanying with pure water (milliQ) of 2 mL including 5.25% sodium hypochlorite as one of oxidized chlorine species, added dimethylformamide (DMF) 0.2 mL as one of nitrogen-organic compounds.

Acetic acid of 0.2 mL is added to the obtained two phase solution stirring with magnetic stirrer, which leads to partially production of chlorine gas and/or the other reactive oxidized chlorine species such as hydrogen hypochlorite in situ. The color of vanadyl (IV) meso-tetraphenyl porphine disappeared within 1 min. The obtained organic phase substance and water phase are separated by extraction funnel and analyzed by UV-Vis, XPS, and SIMS to find significant removal of vanadium from substance to water phase.

More specifically, it was found that a reduction of vanadium concentration in the organic phase substance is over about −81%. An appropriate amount of vanadium oxide is crystallized or solidified and collected from a water phase by vaporizing water. This result showed an efficiency of addition of dimethylformamide (DMF) as one of nitrogen-organic compounds.

As described above, by contacting a halogen-containing chemical or chemicals, i.e., a chlorine-containing chemical or chemicals, with an organic phase substance in a system where an organic phase substance is allowed to coexist with a water phase, and processing it, a heavy element species, vanadium, can be extracted or deposited from the organic phase substance into the water phase.

### Embodiment 5

A 3 mL organic phase substance of solution originating from vanadyl (IV) meso-tetraphenyl porphine as a simple model organic components (non patent literatures 1 and 2) about 10 ppm is subjected accompanying with pure water (milliQ) of 1.5 mL including 5.25% sodium hypochlorite as one of oxidized chlorine species, added dimethylformamide (DMF) 15 mL as one of nitrogen-organic compounds.

Concentrated hydrochloric acid (0.2 mL) is added to the obtained two phase solution stirring with magnetic stirrer, which leads to production of chlorine gas in situ at relatively low concentration. The color of vanadyl (IV) meso-tetraphenyl porphine disappeared within 1 h. The obtained organic phase substance and water phase are separated by extraction funnel and analyzed by UV-Vis, XPS, and SIMS to find significant removal of vanadium from substance to water phase.

More specifically, it was found that a reduction of vanadium concentration in the organic phase substance is over about −96%. An appropriate amount of vanadium oxide is crystallized or solidified and collected from a water phase by vaporizing water.

As described above, by contacting a halogen-containing chemical or chemicals, i.e., a chlorine-containing chemical or chemicals, with an organic phase substance in a system where an organic phase substance is allowed to coexist with a water phase, and processing it, a heavy element species, vanadium, can be extracted or deposited from the organic phase substance into the water phase.

### Embodiment 6

A 3 mL organic phase substance of solution originating from bitumen produced in Alberta, Canada in toluene with a vanadium concentration of ca. 2 ppm, which is filtered by cellulose (advantec No. 5B), is subjected accompanying with pure water (milliQ) of 1 mL including 5.25% sodium hypochlorite as one of oxidized chlorine species, added dimethylformamide (DMF) 15 mL as one of nitrogen-organic compounds.

Concentrated hydrochloric acid (0.2 mL) is added to the obtained two phase solution stirring with magnetic stirrer, which leads to production of chlorine gas in situ at low concentration as compared with the other embodiments. The resulting mixture is stirred for 20 min to 20 h. The obtained organic phase substance and water phase are separated by extraction funnel and the obtained organic phase substance is extracted using fresh water once, and analyzed by UV-Vis, XPS, and SIMS to find significant removal of vanadium from substance to water phase.

More specifically, it was found that a reduction of vanadium concentration in the organic phase substance is over −92%. An appropriate amount of vanadium oxide is crystallized or solidified and collected from a water phase by vaporizing water. An additional fresh water is used, if it is necessary, to remove said heavy element species from said organic phase substance into water phase. An additional fresh water is useful to enhance the efficiency of removal. No precipitation is observed in this case and mass measurements after the removal and collection of the heavy element species revealed the mass lose less than 1%.

As described above, by contacting a halogen-containing chemical or chemicals, i.e., a chlorine-containing chemical or chemicals, with an organic phase substance in a system where an organic phase substance is allowed to coexist with a water phase, and processing it, a heavy element species, vanadium, can be extracted or deposited from the organic phase substance into the water phase. Other than vanadium, iron, nickel, copper, chromium, titanium and arsenic can be extracted.

This clearly indicates appropriate concentration control of chlorine gas as one of the chlorine-containing chemical or chemicals claimed in the present invention is feasible to reduce precipitation and mass loses and to significantly remove heavy element species from organic phase substance in the process.

### Embodiment 7

A facile experimental set-up is illustrated in FIG. 2. To a 3 mL organic phase substance of solution originating from bitumen produced in Alberta, Canada in toluene with a vanadium concentration of ca. 2 ppm, which is filtered by cellulose (advantec No. 5B), is subjected accompanying with pure water (milliQ) of 3 mL including 5.25% sodium hypochlorite as one of oxidized chlorine species and mixed with accetic acid of 1.5 mL.

The resulting two phase solution is heated up at around 60° C., ca. 1.2 atm in capped glassware, vigorously stirring with magnetic stirrer for about 60 min. The obtained organic phase substance and water phase (two phase solution) with small amount of a precipitate ca. 30 mg is separated by filtering and extraction funnel, and analyzed by UV-Vis, XPS, and SIMS to find significant removal of vanadium from organic phase substance to water phase.

More specifically, it was found that a reduction of vanadium concentration in the organic phase substance is about −75% within 1 h. An appropriate amount of vanadium oxide is crystallized or solidified and collected from a water phase by vaporizing water. It is found that the other heavy element species is removed and separated from the organic phase substance into water phase based on SIMS measurements, e.g., iron, copper, nickel, chromium, arsenic, arsine, titanium.

As described above, by contacting a halogen-containing chemical or chemicals, i.e., a chlorine-containing chemical or chemicals, with an organic phase substance in a system where an organic phase substance is allowed to coexist with a water phase, and processing it, a heavy element species, vanadium, can be extracted or deposited from the organic phase substance into the water phase. Other than vanadium, iron, nickel, copper, chromium, titanium and arsenic can be extracted.

These results revealed that the process method is effective for removing and collecting heavy element species from organic phase substance using chlorine-containing chemical or chemicals, accompanying with water only, or with water and added nitrogen-organic compounds (DMF) and organic acids derivatives (acetic acid) at mild environmental conditions less than 100° C. and less than 10 atm, e.g., the temperature less than +30° C. and at atmospheric pressure around 1 atm.

### Embodiment 8

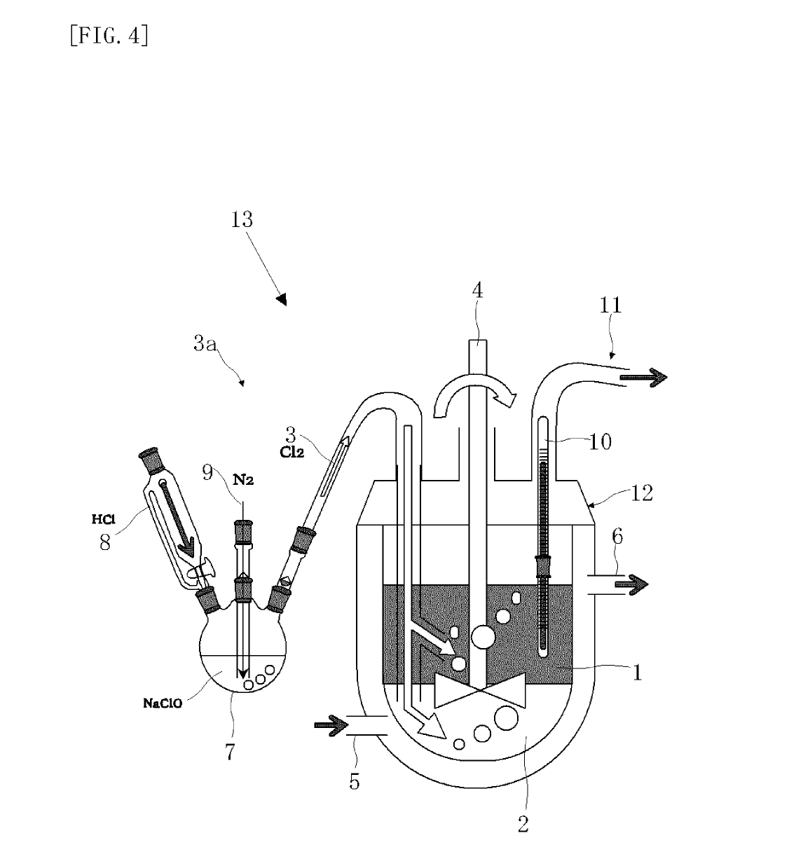

How to process an organic phase substance is shown in FIG. 4. The processing unit 13 for an organic phase substance is constituted of a three-neck glass vessel 12 serving as a site where an organic phase substance 1 is contacted with a water phase 2, a chlorine gas line 3a and a discharged-gas trap 11. The three-neck glass vessel 12 is equipped with a mechanical stirrer 4 and a thermometer 10. The chlorine gas line 3a through which dry nitrogen 9 flows and the discharge gas trap 11, which traps an excessive chlorine gas, are connected to the vessel. Furthermore, outside the three-neck glass vessel 12, there is a space having an inlet 5 and an outlet for a cooling or heating medium.

An organic phase substance solution 1 originating from bitumen (180 g) produced in Alberta, Canada, dissolved in toluene/hexane (200 mL/200 mL), containing vanadium in a concentration of 3 ppm, and accompanying pure water (milliQ) of 200 mL, is subjected to the three-neck glass vessel 12 of the processing unit 13 for an organic phase substance. The two-phase solution was cooled with ice water to about 14 to 18° C.

Total 80 mmol of excessive chlorine gas (chemical 3) based on vanadium concentration is produced by reacting 0.5% sodium hypochlorite and hydrochloric acid (two equivalents) added dropwise from a dropping funnel 8 in a pot 7 shown in FIG. 4, and introduced into the water phase 2 in this case while bubbling with dry nitrogen 9.

Part of chlorine gas (chemical 3) is released from the two-phase solution after bubbling and trapped by an aqueous sodium sulfite solution housed in a bag (discharged-gas trap 11) for safety. The flow rate of dry nitrogen 9 is about 560 mL/min (for about 10 min) in the case of chlorine gas generated by the reaction. Subsequently, nitrogen is bubbled further for about 7 to 10 min.

The mechanical stirrer 4 is rotated at ca. 100 rpm. This one-set procedure is repeated by three times. The obtained organic phase substance and water phase are separated by extraction funnel and analyzed by UV-Vis, XPS, and SIMS to find significant removal of vanadium from organic phase substance to water phase.

More specifically, it was found that a reduction of vanadium concentration in the organic phase substance is from about −31% to −49%. An appropriate amount of vanadium oxide is crystallized or solidified and collected from a water phase by vaporizing water. A part of vanadium oxide is collected by aluminum, silicon oxide, or sand filtering from the obtained water phase.

As described above, by contacting a halogen-containing chemical or chemicals, i.e., a chlorine-containing chemical or chemicals, with an organic phase substance in a system where an organic phase substance is allowed to coexist with a water phase, and processing it, a heavy element species, vanadium, can be extracted or deposited from the organic phase substance into the water phase. Other than vanadium, iron, nickel, copper, chromium, titanium and arsenic can be extracted.

### Embodiment 9

In accordance with the set-up shown in FIG. 4, an organic phase substance solution originating from bitumen (200 g) produced in Alberta, Canada, dissolved in toluene/hexane (200 mL/200 mL) and containing vanadium in a concentration of about 3 ppm is subjected accompanying pure water (milliQ) of 200 mL containing 1% acetic acid (2 mL).

The two phase solution is cooled down at around 10 to 14° C. by ice water. Total 80 mmol of excess chlorine gas based on vanadium concentration is produced by the reaction of 0.5% sodium hypochlorite with two equivalents of hydrochloric acid at the pot 7 in FIG. 4, bubbling dry nitrogen, and injected into the water phase in this case.

Some of chlorine gas is released out from two phase solution after bubbling, which is trapped by using sodium sulfite aqueous solution in a bag for safety. The flow rate of dry nitrogen is around 560 mL/min (for ca. 7 min) providing chlorine gas with the reaction, and then bubbled for additional time ca. 5 to 7 min by dry nitrogen. The mechanical stirrer is rotated at ca. 100 rpm. This one-set procedure is repeated by three times. The obtained organic phase substance and water phase are separated by extraction funnel and analyzed by UV-Vis, XPS, and SIMS to find significant removal of vanadium from organic phase substance to water phase.

More specifically, it was found that a reduction of vanadium concentration in the organic phase substance is from about −30% to −64%. An appropriate amount of vanadium oxide is crystallized or solidified and collected from a water phase by vaporizing water. A part of vanadium oxide is collected by aluminum, silicon oxide, or sand filtering from the obtained water phase. This result showed an efficiency of addition of acetic acid as one of organic acid derivatives.

As described above, by contacting a halogen-containing chemical or chemicals, i.e., a chlorine-containing chemical or chemicals, with an organic phase substance in a system where an organic phase substance is allowed to coexist with a water phase, and processing it, a heavy element species, vanadium, can be extracted or deposited from the organic phase substance into the water phase. Other than vanadium, iron, nickel, copper, chromium, titanium and arsenic can be extracted.

### Embodiment 10

In accordance with the set-up shown in FIG. 4, a 3 mL of an organic phase substance of solution originating from bitumen (203 g) produced in Alberta, Canada in toluene/hexane (200 mL/200 mL) with a vanadium concentration of ca. 3 ppm, is subjected accompanying with pure water (milliQ) of 200 mL including dimethylformamide 1% (DMF, 2 mL).

The two phase solution is cooled down at around 12 to 15° C. by ice water. Total 80 mmol of excess chlorine gas based on vanadium concentration is produced by the reaction of 0.5% sodium hypochlorite with two equivalents of hydrochloric acid at the pot 7 in FIG. 4, bubbling dry nitrogen, and injected into the water phase in this case. Some of chlorine gas is released out from two phase solution after bubbling, which is trapped by using sodium sulfite aqueous solution in a bag for safety.

The flow rate of dry nitrogen is around 560 mL/min (for ca. 12 min) providing chlorine gas with the reaction, and then bubbled for additional time ca. 5 to 9 min by dry nitrogen. The mechanical stirrer is rotated at ca. 100 rpm. This one-set procedure is repeated by three times.

The obtained organic phase substance and water phase are separated by extraction funnel and analyzed by UV-Vis, XPS, and SIMS to find significant removal of vanadium from organic phase substance to water phase, an additional fresh water is used, if it is necessary, to remove said heavy element species from said organic phase substance into water phase, the water is useful to enhance the efficiency of removal.

More specifically, reduction of vanadium concentration is observed in organic phase substance from about −57 to −91%, and vanadium oxide is collected from water phase after crystallization by vaporizing water. A part of vanadium oxide is collected by aluminum, silicon oxide, or sand filtering from the obtained water phase. This result showed an efficiency of addition of DMF as one of nitrogen-organic compounds.

As described above, by contacting a halogen-containing chemical or chemicals, i.e., a chlorine-containing chemical or chemicals, with an organic phase substance in a system where an organic phase substance is allowed to coexist with a water phase, and processing it, a heavy element species, vanadium, can be extracted or deposited from the organic phase substance into the water phase. Other than vanadium, iron, nickel, copper, chromium, titanium and arsenic can be extracted.

### Embodiment 11

In accordance with the set-up shown in FIG. 4, an organic phase substance of solution originating from bitumen (206 g) produced in Alberta, Canada in toluene/hexane (200 mL/200 mL) with a vanadium concentration of ca. 3 ppm, is subjected accompanying with pure water (milliQ) of 200 mL including acetic acid 1% (2 mL).

The two phase solution is cooled down at around 8 to 11° C. by ice water. Total 80 mmol of excess chlorine gas based on vanadium concentration is produced by the reaction of 0.5% sodium hypochlorite with two equivalents of hydrochloric acid at the pot 7 in FIG. 4, bubbling dry nitrogen, and injected into the organic phase substance in this case. Some of chlorine gas is released out from two phase solution after bubbling, which is trapped by using sodium sulfite aqueous solution in a bag for safety.

The flow rate of dry nitrogen is around 560 mL/min (for ca. 10 min) providing chlorine gas with the reaction, and then bubbled for additional time ca. 5 min by dry nitrogen. The mechanical stirrer is rotated at ca. 600 rpm. This one-set procedure is repeated by three times. The obtained organic phase substance and water phase formed an emulsion or miscall type substance in this case.

The organic phase substance and water phase are separated by sonication (ca. 60 Hz) and centrifugal force (1500 to 2500 rpm) in this case, and analyzed by UV-Vis, XPS, and SIMS to find significant removal of vanadium from organic phase substance to water phase.

More specifically, it was found that a reduction of vanadium concentration in the organic phase substance is from about −70% to −98%. An appropriate amount of vanadium oxide is crystallized or solidified and collected from a water phase by vaporizing water. A part of vanadium oxide is collected by aluminum, silicon oxide, or sand filtering from the obtained water phase.

As described above, by contacting a halogen-containing chemical or chemicals, i.e., a chlorine-containing chemical or chemicals, with an organic phase substance in a system where an organic phase substance is allowed to coexist with a water phase, and processing it, a heavy element species, vanadium, can be extracted or deposited from the organic phase substance into the water phase. Other than vanadium, iron, nickel, copper, chromium, titanium and arsenic can be extracted.

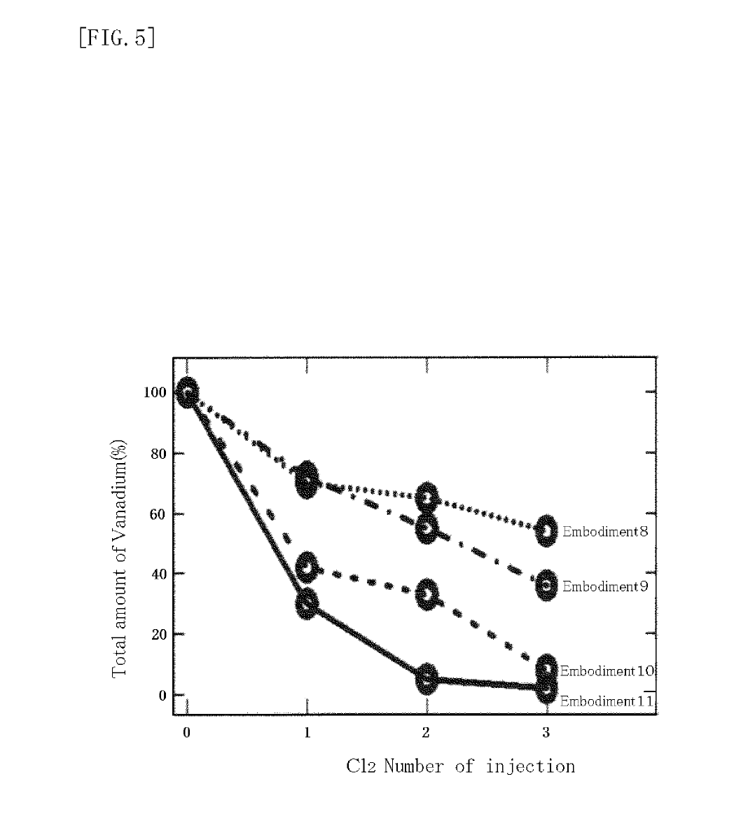

This result indicated an effect about how to contact and mix chlorine gas upon the removal of heavy element species from organic phase substance. The results in Embodiments 8 to 11 are concluded in FIG. 5.

### Embodiment 12

As shown in FIG. 5, organic components of asphaltene are obtained as a precipitation after the process shown in Embodiments 8 to 11, generally using said chlorine-containing chemical, total amount, ca. 30 mg (Embodiment 7) 18-24 g (Embodiment 8), 15-21 g (Embodiment 9), 6-12 g (Embodiment 10), and 52 g (Embodiment 11).

After the process shown in Embodiments 8 to 11, viscosity of organic phase substance of the bitumen decreased to be better oil liquid. The amount of these precipitations can be controlled by how to contact and mix the chlorine gas into organic phase substance.

The amount of these precipitations can remarkably decrease when molarity of excess chlorine is reduced. It is found that obtained precipitations consist of organic components of asphaltene consist of chloro-organic molecules and inorganic substances such as silicon or aluminum oxide, based on XPS measurements, with relatively large molecular weights and relatively low solubility.

This result indicates that chlorine-containing chemical or chemicals are effective in removing organic components of asphaltene and inorganic substances, which originally have a large molecular weights and relatively low solubility, from an organic phase substance, and that a specific reaction with the chlorine-containing chemical or chemicals occurs probably at the interface of the organic components of asphaltene and the inorganic substances.

### Embodiment 13

To a 4 mL organic phase substance of solution originating from tar with relatively low viscosity produced in USA in toluene/petroleum ether (1/1) with a vanadium concentration of ca. 1 ppm, which is filtered by cellulose (advantec No. 5B), is subjected accompanying with pure water (milliQ) of 2 mL.

The two phase solution of organic phase substance and water phase is mixed with vigorous stirring and exposed and contacted at room temperature to the chlorine gas afforded by the reaction of ca 1% sodium hypochlorite with two equivalents of hydrochloric acid in closed box for 58 min. The obtained organic phase substance and water phase (two phase solution) with a precipitate is separated by sonication and extraction funnel and filtering, and analyzed by UV-Vis, XPS, and SIMS to find significant removal of vanadium from organic phase substance to water phase.

More specifically, it was found that a reduction of vanadium concentration in the organic phase substance is over about −84%. An appropriate amount of vanadium oxide is crystallized or solidified and collected from a water phase by vaporizing water.

As described above, by contacting a halogen-containing chemical or chemicals, i.e., a chlorine-containing chemical or chemicals, with an organic phase substance in a system where an organic phase substance is allowed to coexist with a water phase, and processing it, a heavy element species, vanadium, can be extracted or deposited from the organic phase substance into the water phase. Other than vanadium, iron, nickel, copper, chromium, titanium and arsenic can be extracted.

### Embodiment 14

To a 4 mL organic phase substance of solution originating from oilsand produced in Alberta, Canada in toluene/petroleum ether (1/1) with a nickel concentration of ca. 0.5 ppm (with trace vanadium in this case), which is filtered by cellulose (advantec No. 5B) with toluene before reaction, is subjected accompanying with pure water (milliQ) of 2 mL.

The two phase solution of organic phase substance and water phase is mixed with vigorous stirring and exposed and contacted at room temperature to the chlorine gas afforded by the reaction of ca 1% sodium hypochlorite with two equivalents of hydrochloric acid in closed box for 58 min. The obtained organic phase substance and water phase (two phase solution) with a precipitate is separated by sonication and extraction funnel and filtering, and analyzed by UV-Vis, XPS, and SIMS to find significant removal of nickel from organic phase substance to water phase.

More specifically, it was found that a reduction of nickel concentration in the organic phase substance is over about −90%. An appropriate amount of nickel is crystallized or solidified and collected from a water phase by vaporizing water.

As described above, by contacting a halogen-containing chemical or chemicals, i.e., a chlorine-containing chemical or chemicals, with an organic phase substance in a system where an organic phase substance is allowed to coexist with a water phase, and processing it, a heavy element species, nickel, can be extracted or deposited from the organic phase substance into the water phase. Other than nickel, iron, copper, chromium, titanium and arsenic can be extracted.

### Embodiment 15

To a 4 mL organic phase substance of solution originating from the other oilsand produced in Alberta, Canada in toluene/petroleum ether (1/1) with a vanadium and nickel concentration of ca. 2 ppm and 0.5 ppm, respectively, which is filtered by cellulose (advantec No. 5B) with toluene before reaction, is subjected accompanying with pure water (milliQ) of 2 mL.

The two phase solution of organic phase substance and water phase is mixed with vigorous stirring and exposed and contacted at room temperature to the chlorine gas afforded by the reaction of ca 1% sodium hypochlorite with two equivalents of hydrochloric acid in closed box for 58 min. The obtained organic phase substance and water phase (two phase solution) with a precipitate is separated by sonication and extraction funnel and filtering, and analyzed by UV-Vis, XPS, and SIMS to find significant removal of vanadium and nickel from organic phase substance to water phase.

More specifically, it was found that a reduction of vanadium and nickel concentration in the organic phase substance is about −90% and −100%, respectively. An appropriate amount of vanadium oxide and nickel ion is crystallized or solidified and collected from a water phase by vaporizing water.

As described above, by contacting a halogen-containing chemical or chemicals, i.e., a chlorine-containing chemical or chemicals, with an organic phase substance in a system where an organic phase substance is allowed to coexist with a water phase, and processing it, a heavy element species, vanadium and nickel, can be extracted or deposited from the organic phase substance into the water phase. Other than vanadium and nickel, iron, copper, chromium, titanium and arsenic can be extracted.

### Embodiment 16

A 1.8 g organic phase substance of powder originating from cokes produced in Edmonton, Canada with a vanadium, copper, nickel concentration of ca. 670 ppm, 22 ppm, and 373 ppm, respectively, is mixed accompanying with water of 3 mL including ca 1.7% sodium hypochlorite with two equivalents of hydrochloric acid in closed box.

The suspension of organic phase substance accompanying with water phase is heated up at ca. 60 to 80° C. in closed box for 2.5 h. The obtained organic phase substance and water phase are separated by filtering, and analyzed by XPS, and SIMS to find partially removal of vanadium, copper, and nickel from organic phase substance to water phase, removal rate less than 68% and a moderate increase of vanadium and nickel is observed in water phase.

It is found the removal of the other heavy element species such as iron, manganese, molybdenum, nickel, chromium, copper, titanium, indium, and yttrium from the organic phase substance into water phase. Vanadium oxide, nickel ions and the other heavy element species are moderately crystallized or solidified and collected from water phase by vaporizing water.

### Embodiment 17

A 1.8 g organic phase substance of powder originating from cokes produced in Edmonton, Canada with a vanadium, copper, nickel concentration of ca. 670 ppm, 22 ppm, and 373 ppm, respectively, is mixed accompanying with water of 3 mL including ca 1.7% sodium hypochlorite with 0.5 mL acetic acid in closed box.

The suspension of organic phase substance accompanying with water phase is heated up at ca. 60 to 80° C. in closed box for 2.5 h. The obtained organic phase substance and water phase are separated by filtering, and analyzed by XPS, and SIMS to find partially removal of vanadium, copper, and nickel from organic phase substance to water phase, removal rate less than 17% and a moderate increase of vanadium and nickel is observed in water phase.

It is found the removal of the other heavy element species such as iron, manganese, molybdenum, nickel, chromium, copper, titanium, indium, and yttrium from the organic phase substance into water phase. Vanadium oxide, nickel ions and the other heavy element species are moderately crystallized or solidified and collected from water phase by vaporizing water.

These results clearly indicate the process method for removing and collecting vanadium oxide as one of the heavy element species and organic components of asphaltene from organic phase substance using chlorine gas as one of pivotal chlorine-containing chemicals, accompanying with water only, or with water and added nitrogen-organic compounds (DMF) and organic acids derivatives (acetic acid), works well at mild environmental conditions less than 100° C. and less than 10 atm, e.g., the temperature less than +30° C. and at atmospheric pressure around 1 atm in short time.

These results showed many kinds of organic phase substance can be processed and removed heavy element species and organic components of asphaltene therefore chlorine-containing chemical or chemicals are applicable to many kinds of organic phase substance include the other carbon-based substances.

Further, these results are responsible for the ability of chlorine-containing chemical or chemicals because it is observed that only water or only aqueous solution of acid such as hydrochloric acid, sulfuric acid, and acetic acid, and strong alkalis such as sodium hydroxide and potassium hydroxide, are not effective at temperature in the range of room temperature to ca 100° C. to remove vanadium species as one of heavy element species into water phase from organic phase substance; removal efficiency below 1% for each, specifically at room temperature around 20° C., within 1 hour.

### Embodiment 18

An aqueous solution including 10% sodium chloride, 3% magnesium chloride, and 7% magnesium bromide about 100 mL is divided to two beakers connecting a glass pipe of salt bridge consisting of agarose gel and sodium chloride.

A carbon anode electrode and a platinum cathode electrode are set in each beaker and applied about 9V using a battery. A gas produced from the carbon anode electrode is collected in vinyl bag and subsequently is contacted to a 2 mL toluene solution of vanadyl (IV) meso-tetraphenyl porphine (ca 107 ppm) as a simple model organic components of organic phase substance accompanying about 1 mL of water to observe a color disappearance of the porphine.

The same kind of color disappearance is observed when the solution of the beaker of carbon anode electrode is contacted to the porphine solution. After the process it is found that vanadium oxide species is collected in water phase based on XPS measurements.

Interhalogen compounds such as bromine-monochloride, and/or chlorine radical, and/or oxidized chlorine species are produced other than chlorine gas in the anode aqueous solution in the case of this electrolysis, therefore these results clearly indicate that chlorine-containing species prepared by electrochemical reaction (electrolysis) of any kind of aqueous solutions including at least alkali metal chloride and/or alkali earth metal chloride or the other halide on anode electrode is used for removing and/or collecting heavy element species from organic phase substance accompanying water phase.

On the other hand, hydrogen gas and sodium hydroxide are afforded from the cathode electrode which are used for the other process such as a upgrading of bitumen, or hydrodehalogenation (hydrodechlorination, hydrodebromination, hydrodeiodination), hydrodesulfurization, or hydrodenitrogenation.

### Embodiment 19

It is found that the bitumen after the process described in Embodiments 8 to 11 contained a significant chloride species based on XPS and SIMS measurements, presumably the reaction of chlorine gas and aromatics of organic components in bitumen. Therefore in this Embodiment hydrodechlorination reaction is performed to remove chloride species in the obtained bitumen.

To the bitumen of ca. 3 g after the removal of heavy element species is added sodium hydroxide and 2-propyl alcohol (isopropanol, IPA) instead of hydrogen gas as a source of hydrogen for this hydrogen-chloride exchange reaction, and the resulting mixture is heated at around 80° C. for 7 h in the presence of palladium/carbon (Pd: 10 wt %) catalyst about 80 mg.

XPS and SIMS measurements revealed that chloride species, i.e., chloride organic molecules significantly decrease up to as low as about −56% after the hydrodechlorination, with the result that salts such as sodium chloride can be obtained. The hydrodechlorination reaction is suitably applied to other types of hydrodehalogenation such as hydrodebromination and hydrodeiodination because the binding energy of carbon-bromide and -iodide are low.

As mentioned above, it is obvious that all or partial chemical or chemicals claimed in above claims are recycled, including salts such as sodium chloride, said chemical or chemicals, water phase, organic solvent, alkali such as sodium hydroxide, gas such as chlorine-containing chemical or chemicals and hydrogen, catalyst, and the other materials which are essential to said method and said process in the present invention.

### Embodiment 20

Heavy element species combined in water phase with potassium sulfate is subjected at a cell of hand-made portable electrochemical box, connecting a working electrode (carbon), a reference electrode (Ag/AgCl), and a counter electrode (Pt). About the voltage from −2 to −8V is applied on the carbon electrode and the obtained surface is analyzed by XPS and SIMS to find vanadium, nickel, and/or copper metals on it. This clearly shows that the conversion into heavy element species or alloys from obtained heavy element species by using plating or reductive reactions, to collect heavy element species or alloys by electrochemical reactions on cathode, plating techniques from said water phase including heavy element species after the removal from organic phase substance.

### Embodiment 21

A 2 mL organic phase substance of solution originating from vanadyl (IV) meso-tetraphenyl porphine as one of organic components in bitumen or tar in toluene with concentration about 107 ppm, is subjected accompanying with pure water (milliQ) of 4 mL and the temperature of solution is maintained at 60° C.

Liquid bromine (0.4 mL) is mixed to the obtained two phase solution, organic phase substance and water phase, stirring with magnetic stirrer for 9 hours. The obtained organic phase substance and water phase (two phase solution) are separated by extraction funnel and analyzed by SIMS to find a removal of vanadium from organic phase substance to water phase.

More specifically, it was found that a reduction of vanadium concentration in the organic phase substance is about from −11%. An appropriate amount of vanadium oxide is crystallized or solidified and collected from a water phase by vaporizing water.

As described above, by contacting a halogen-containing chemical or chemicals, i.e., a bromine-containing chemical or chemicals, with an organic phase substance in a system where an organic phase substance is allowed to coexist with a water phase, and processing it, a heavy element species, vanadium, can be extracted or deposited from the organic phase substance into the water phase.

### Embodiment 22

A 2 mL organic phase substance of solution originating from vanadyl (IV) meso-tetraphenyl porphine as one of organic components in bitumen or tar in toluene with concentration about 107 ppm, is subjected accompanying with pure water (milliQ) of 4 mL and the temperature of solution is maintained at 60° C. Liquid bromine (0.4 mL) and potassium bromated (20 mg) are mixed to the obtained two phase solution, organic phase substance and water phase, stirring with magnetic stirrer for 3 hours. The obtained organic phase substance and water phase (two phase solution) are separated by extraction funnel and analyzed by SIMS to find a removal of vanadium from organic phase substance to water phase.

More specifically, it was found that a reduction of vanadium concentration in the organic phase substance is about from −16%. An appropriate amount of vanadium oxide is crystallized or solidified and collected from a water phase by vaporizing water.

As described above, by contacting a halogen-containing chemical or chemicals, i.e., a bromine-containing chemical or chemicals, with an organic phase substance in a system where an organic phase substance is allowed to coexist with a water phase, and processing it, a heavy element species, vanadium, can be extracted or deposited from the organic phase substance into the water phase.

### Embodiment 23

To a 3 mL organic phase substance of solution originating from bitumen produced in Alberta, Canada in toluene with a vanadium concentration of ca. 2 ppm, which is filtered by cellulose (advantec No. 5B), is subjected accompanying with pure water (milliQ) of 2 mL and the temperature of solution is maintained at 80° C.

Liquid bromine (0.6 mL) and potassium bromated (40 mg) are mixed to the obtained two phase solution, organic phase substance and water phase, stirring with magnetic stirrer for 3 hours. The obtained organic phase substance and water phase (two phase solution) are separated by extraction funnel and analyzed by SIMS to find a removal of vanadium from organic phase substance to water phase.

More specifically, it was found that a reduction of vanadium concentration in the organic phase substance is about from −34%. An appropriate amount of vanadium oxide is crystallized or solidified and collected from a water phase by vaporizing water.

As described above, by contacting a halogen-containing chemical or chemicals, i.e., a bromine-containing chemical or chemicals, with an organic phase substance in a system where an organic phase substance is allowed to coexist with a water phase, and processing it, a heavy element species, vanadium, can be extracted or deposited from the organic phase substance into the water phase.

These results using bromine or mixture of bromine and bromate clearly indicate the process method for removing and collecting vanadium oxide as one of the heavy element species from organic phase substance using bromine-containing chemical or chemicals accompanying water phase works at mild environmental conditions, i.e., the temperature less than +100° C. and at atmospheric pressure around 1 atm.

### Embodiment 24

A 2 mL organic phase substance of solution originating from vanadyl (IV) meso-tetraphenyl porphine as one of organic components in bitumen or tar in toluene with concentration about 107 ppm, is subjected accompanying with pure water (milliQ) of 5 mL and the temperature of solution is maintained at 60° C.

A mixture of iodine (10 mg) and sodium periodate (60 mg) as an oxidized iodine species are mixed to the obtained two phase solution, organic phase substance and water phase, stirring with magnetic stirrer for 28 hours. The obtained organic phase substance and water phase (two phase solution) are separated by extraction funnel and analyzed by SIMS to find a removal of vanadium from organic phase substance to water phase.

More specifically, it was found that a reduction of vanadium concentration in the organic phase substance is about from −37%. An appropriate amount of vanadium oxide is crystallized or solidified and collected from a water phase by vaporizing water.

As described above, by contacting a halogen-containing chemical or chemicals, i.e., an iodine-containing chemical or chemicals with an organic phase substance in a system where an organic phase substance is allowed to coexist with a water phase, and processing it, a heavy element species, vanadium, can be extracted or deposited from the organic phase substance into the water phase.

### Embodiment 25

A 2 mL organic phase substance of solution originating from bitumen produced in Alberta, Canada in toluene with a vanadium concentration of ca. 2 ppm, which is filtered by cellulose (advantec No. 5B), is subjected accompanying with pure water (milliQ) of 2 mL and the temperature of solution is maintained at 70° C.

A mixture of iodine (15 mg) and sodium periodate (100 mg) as an oxidized iodine species are mixed to the obtained two phase solution, organic phase substance and water phase, stirring with magnetic stirrer for 24 hours. The obtained organic phase substance and water phase (two phase solution) are separated by extraction funnel and analyzed by SIMS to find a removal of vanadium from organic phase substance to water phase.

More specifically, it was found that a reduction of vanadium concentration in the organic phase substance is about from −33%. An appropriate amount of vanadium oxide is crystallized or solidified and collected from a water phase by vaporizing water.

As described above, by contacting a halogen-containing chemical or chemicals, i.e., an iodine-containing chemical or chemicals, with an organic phase substance in a system where an organic phase substance is allowed to coexist with a water phase, and processing it, a heavy element species, vanadium, can be extracted or deposited from the organic phase substance into the water phase.

It is known that the reaction between iodine and periodate furnish an iodine cation or radical species in situ. Therefore, the result using iodine and periodate clearly indicate the process method for removing and collecting vanadium oxide as one of the heavy element species from organic phase substance using mixture of iodine and oxidized iodine species such as sodium periodate or periodic acid, or iodine cation or radical species accompanying water phase works at mild environmental conditions, i.e., the temperature less than +100° C. and at atmospheric pressure around 1 atm. In the case of said bromine-containing and said iodine-containing chemical or chemicals, no precipitation is observed after the reactions therefore those cases are suitable to reduce precipitation and mass loses in the process.

### Embodiment 26

A 3.3 mL organic phase substance of solution originating from vanadyl (IV) meso-tetraphenyl porphine in toluene with concentration about 107 ppm, is subjected accompanying with pure water (milliQ) of 1.5 mL including maleic acid (100 mg) and DMF (0.5 mL), and the temperature of two phase solution is maintained at 60 to 80° C.

30% Hydrogen peroxide (0.5 mL) is added to the obtained two phase solution stirring with magnetic stirrer for 2 hours. The obtained organic phase substance and water phase (two phase solution) are separated by extraction funnel and analyzed by SIMS to find a removal of vanadium from organic phase substance to water phase.

More specifically, it was found that a reduction of vanadium concentration in the organic phase substance is about from −87%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

### Embodiment 27

A 3.3 mL organic phase substance of solution originating from vanadyl (IV) meso-tetraphenyl porphine in toluene with concentration about 107 ppm, is subjected accompanying with pure water (milliQ) of 1.5 mL including benzoic acid (160 mg) and DMF (0.5 mL), and the temperature of two phase solution is maintained at 80 to 90° C.

30% Hydrogen peroxide (0.5 mL) is added to the obtained two phase solution stirring with magnetic stirrer for 2 hours. The obtained organic phase substance and water phase (two phase solution) are separated by extraction funnel and analyzed by SIMS to find a removal of vanadium from organic phase substance to water phase.

More specifically, it was found that a reduction of vanadium concentration in the organic phase substance is about from −62%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

### Embodiment 28

A 3.3 mL organic phase substance of solution originating from vanadyl (IV) meso-tetraphenyl porphine in toluene with concentration about 107 ppm, is subjected accompanying with pure water (milliQ) of 1 mL including acetic acid (0.5 mL), and the temperature of two phase solution is maintained at 80 to 90° C.

30% Hydrogen peroxide (0.5 mL) is added to the obtained two phase solution stirring with magnetic stirrer for 17 hours. The obtained organic phase substance and water phase (two phase solution) are separated by extraction funnel and analyzed by SIMS to find a removal of vanadium from organic phase substance to water phase.

More specifically, it was found that a reduction of vanadium concentration in the organic phase substance is about from −29%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

### Embodiment 29

A 2 mL organic phase substance of solution originating from vanadyl (IV) meso-tetraphenyl porphine in toluene with concentration about 107 ppm, is subjected accompanying with pure water (milliQ) of 1 mL including catalytic 1,4,5,8-naphtalene-tetracarboxylic acid (20 mg) as one of naphthalene carboxylic acid in organic acids derivatives, and tetradodecylammonium bromide as one of nitrogen-organic compounds, and zinc nitrate (260 mg) as an additives, and excess hydrogen peroxide.

The temperature of two phase solution is maintained at 60 to 80° C. for 19 h. The obtained organic phase substance and water phase (two phase solution) are separated by extraction funnel and analyzed by SIMS to find a removal of vanadium from organic phase substance to water phase.

More specifically, it was found that a reduction of vanadium concentration in the organic phase substance is about −10%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

### Embodiment 30

A 3.3 mL organic phase substance of solution originating from vanadyl (IV) meso-tetraphenyl porphine in toluene with concentration about 107 ppm, is subjected accompanying with pure water (milliQ) of 1 mL including catalytic maleic acid (1.4 mg, ca. 3.3 mol % based on porphine) as one of organic acids derivatives, and catalytic tetradodecylammonium bromide (1 mg) and DMF (0.05 mL) as nitrogen-organic compounds, and excess hydrogen peroxide (30%, 1 mL). The temperature of two phase solution is maintained at 80 to 90° C. for ca. 24 h.

The obtained organic phase substance and water phase (two phase solution) are separated by extraction funnel and analyzed by SIMS to find a removal of vanadium from organic phase substance to water phase. More specifically, it was found that a reduction of vanadium concentration in the organic phase substance is about −13%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

This result indicates a catalytic reaction of organic acid derivatives to remove and collect heavy element species from organic phase substance using mixture of catalytic organic acid derivatives because only excess hydrogen peroxide, and only ammonium halide such as chloride, bromide or iodide anion, and only DMF as one of nitrogen-organic compounds show no significant removal of vanadium and the amount of organic acid derivatives less than 4 percent against vanadyl (IV) meso-tetraphenyl porphine realized about 4 times larger −13% reduction of the heavy element species from organic phase substance.

### Embodiment 31

A 3 mL organic phase substance of solution originating from bitumen produced in Alberta, Canada in toluene with a vanadium concentration of ca. 2 ppm, which is filtered by cellulose (advantec No. 5B), is subjected accompanying with pure water (milliQ) of 1 mL including catalytic maleic acid (0.1 mg) as one of organic acids derivatives and catalytic tetradodecylammonium bromide (0.1 mg) in DMF (0.05 mL) as nitrogen-organic compounds, and excess hydrogen peroxide (30%, 1 mL) and sulfuric acid (2 mg).

The temperature of two phase solution is maintained at 85° C. for ca. 24 h. The obtained organic phase substance and water phase (two phase solution) are separated by extraction funnel and analyzed by SIMS to find a removal of vanadium from organic phase substance to water phase. More specifically, it was found that a reduction of vanadium concentration in the organic phase substance is about −19%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

These results using organic acids indicate that many types of organic acids such as aromatic or aliphatic organic carboxylic acid and naphthenic acids work in a mild environmental condition for removing and collecting heavy element species from organic phase substance. In the case of said mixture of hydrogen peroxide and organic acids, no precipitation is observed after the reactions therefore those cases are suitable to reduce precipitation and mass loses in the process.

### Embodiment 32

A 3 mL organic phase substance solution originating from bitumen produced in Alberta, Canada dissolved in toluene, containing vanadium in a concentration of about 2 ppm, and filtered by cellulose (advantec No. 5B), accompanying a solution (1 mL) of pure water (milliQ) containing organic carbonyl analogues, i.e., naphthenic acid (30 mg) and excessive hydrogen peroxide (30%, 1 mL) is subjected.

The two-phase solution is maintained at a temperature of 85° C. for about 12 hours. The obtained organic phase substance and water phase (two-phase solution) are separated by an extraction funnel and analyzed by XPS and SIMS. As a result, it was found that vanadium was removed from an organic phase substance into a water phase.

More specifically, a reduction of vanadium concentration in the organic phase substance was found to be about −59%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

These results obtained by using organic acids indicate that many types of organic acids such as aromatic or aliphatic organic carboxylic acids appropriately work for extracting or depositing and/or collecting heavy element species from an organic phase substance in the presence of hydrogen peroxide. In the case of the mixture of hydrogen peroxide, organic acids and naphthenic acid, no precipitation is observed after the reaction. Therefore, this case is suitably used for reducing precipitation and mass loss in the process.

### Embodiment 33

An organic phase substance solution (3 mL) of about 45 ppm in concentration originating from vanadyl (IV) meso-tetraphenylporphin dissolved in toluene, accompanying hydrogen peroxide (about 30%, 1 mL) additionally added in the presence of acetic acid (0.1 mL) and a pure water (milliQ) of 1 mL is subjected.

The obtained solution is bubbled by injecting about 2 mL of chlorine gas by a syringe. The two-phase solution is maintained at a temperature of about 60° C. for 12 hours. The obtained organic phase substance and water phase (two-phase solution) are separated by an extraction funnel and analyzed by SIMS. It was found that vanadium was removed from an organic phase substance into a water phase.

More specifically, a reduction of vanadium concentration in the organic phase substance was found to be about −36%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

### Embodiment 34

A an organic phase substance solution (3 mL) originating from bitumen produced in Alberta, Canada dissolved in toluene having a vanadium concentration of about 2 ppm, filtered by cellulose (advantec No. 5B) accompanying a mixture of an organic carbonyl analogue, i.e., acetone (0.5 mL) and an aqueous hydrogen peroxide solution (about 10%, 1 mL) in the presence of acetic acid (0.1 mL) is subjected.

The two-phase solution is maintained in a closed container at a temperature of 85° C. for about 12 hours. The obtained organic phase substance and the water phase (two-phase solution), is separated by an extraction funnel and analyzed by SIMS. As a result, it was found that vanadium was removed from the organic phase substance into the water phase.

More specifically, a reduction of vanadium concentration in the organic phase substance was found to be about −9%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

### Embodiment 35

An organic phase substance solution (3 mL) of about 45 ppm in concentration originating from vanadyl (IV) meso-tetraphenylporphin dissolved in toluene, accompanying hydrogen peroxide (about 30%, 1 mL) additionally added and a pure water (milliQ) of 1 mL is subjected.

To the resultant solution, benzyl (10 mg) in DMF (0.1 mL) is added. The two-phase solution is maintained in a closed container at a temperature at 85° C. for about 12 hours. The obtained organic phase substance and water phase (two-phase solution) are separated by an extraction funnel and analyzed by XPS and SIMS. As a result, it was found that vanadium was removed from an organic phase substance into a water phase.

More specifically, a reduction of vanadium concentration in the organic phase substance was found to be about −28%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

### Embodiment 36

An organic phase substance solution (3.3 mL) of about 52 ppm in concentration originating from vanadyl (IV) meso-tetraphenylporphin dissolved in toluene accompanying a solution (1 mL) of pure water (milliQ) containing a benzophenone derivative of the organic carbonyl analogues, i.e., 4-benzoyl benzoate (90 mg) in DMF (0.3 mL) is subjected.

The two-phase solution is maintained in a closed container at a temperature of 80 to 90° C. A 30% aqueous hydrogen peroxide solution (0.5 mL) is added stirring by a magnetic stirrer for 2 hours. The obtained organic phase substance and the water phase (two-phase solution) are separated by an extraction funnel and analyzed by XPS and SIMS. As a result, it was found that vanadium was removed from the organic phase substance into the water phase.

More specifically, a reduction of vanadium concentration in the organic phase substance was found to be about −68%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

These results obtained by using organic acids indicate that many types of organic carbonyl analogues, such as aromatic or aliphatic organic carboxylic acids, appropriately work for extracting or depositing and/or collecting heavy element species from an organic phase substance in the presence of hydrogen peroxide. In the case of a mixture of hydrogen peroxide and organic acids and naphthenic acid, no precipitation is observed after the reaction. Therefore, this case is suitably used for reducing precipitation and mass loss in the process.

The removal reaction by a method of processing heavy element species does not proceed in the presence of hydrogen peroxide alone or an organic acid derivative alone or organic carbonyl analogue or analogues alone.

### Embodiment 37

The ozone-containing water phase is prepared by UV rays irradiation using high-pressure mercury vapor lamp in a water phase saturated with oxygen. An organic phase substance solution (3 mL) of about 52 ppm in concentration originating from vanadyl (IV) meso-tetraphenylporphin dissolved in toluene, accompanying pure water (milliQ) of 1 mL is subjected and the two-phase solution is maintained at a temperature of about 40° C.

The prepared ozone water (2 mL) is added to the obtained two-phase solution while stirring by a magnetic stirrer for 1 hour. The resultant organic phase substance and water phase (two-phase solution) are separated by a separation funnel and analyzed by XPS and SIMS. It was found that vanadium was removed from the organic phase substance into the water phase.

More specifically, a reduction of vanadium concentration in the organic phase substance was found to be about −49%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

### Embodiment 38

The ozone-containing water phase is prepared by UV rays irradiation using high-pressure mercury vapor lamp in a water phase saturated with oxygen. An organic phase substance solution (3 mL) of about 52 ppm in concentration originating from vanadyl (IV) meso-tetraphenylporphin dissolved in toluene, accompanying pure water (milliQ) of 1 mL containing maleic acid (10 mg) is subjected and the two-phase solution is maintained at a temperature of about 40° C.

The prepared ozone water (2 mL) is added to the obtained two-phase solution while stirring by a magnetic stirrer for 1 hour. The resultant organic phase substance and water phase (two-phase solution) are separated by a separation funnel and analyzed by XPS and SIMS. It was found that vanadium was removed from the organic phase substance into the water phase.

More specifically, a reduction of vanadium concentration in the organic phase substance was found to be about −63%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

### Embodiment 39

The ozone-containing water phase is prepared by UV rays irradiation using high-pressure mercury vapor lamp in a water phase saturated with oxygen. An organic phase substance solution (3 mL) of about 52 ppm in concentration originating from vanadyl (IV) meso-tetraphenylporphin dissolved in toluene, accompanying pure water (milliQ) of 1 mL containing 1-naphthalene acid (20 mg) is subjected and the two-phase solution is maintained at a temperature of about 40° C.

The prepared ozone water (2 mL) is added to the obtained two-phase solution while stirring by a magnetic stirrer for 1 hour. The resultant organic phase substance and water phase (two-phase solution) are separated by a separation funnel and analyzed by XPS and SIMS. It was found that vanadium was removed from the organic phase substance into the water phase.

More specifically, a reduction of vanadium concentration in the organic phase substance was found to be about −63%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

### Embodiment 40

The ozone-containing water phase is prepared by UV rays irradiation using high-pressure mercury vapor lamp in a water phase saturated with oxygen. An organic phase substance solution (3 mL) of about 52 ppm in concentration originating from vanadyl (IV) meso-tetraphenylporphin dissolved in toluene, accompanying pure water (milliQ) of 1 mL containing phthalic anhydride (15 mg) in DMF (20 mg) is subjected and the two-phase solution is maintained at a temperature of about 40° C.

The prepared ozone water (2 mL) is added to the obtained two-phase solution while stirring by a magnetic stirrer for 1 hour. The resultant organic phase substance and water phase (two-phase solution) are separated by a separation funnel and analyzed by XPS and SIMS. It was found that vanadium was removed from the organic phase substance into the water phase.

More specifically, a reduction of vanadium concentration in the organic phase substance was found to be about −65%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

### Embodiment 41

The ozone-containing water phase is prepared by UV rays irradiation using high-pressure mercury vapor lamp in a water phase saturated with oxygen. An organic phase substance solution (3 mL) of about 52 ppm in concentration originating from vanadyl (IV) meso-tetraphenylporphin dissolved in toluene, accompanying an aqueous hydrogen peroxide solution (1 mL) containing a mixture of acetic acid (20 mg), valeric acid (20 mg) and benzoic acid (20 mg) as a naphthenic acid-analogue mixture is subjected. The two-phase solution is maintained at a temperature of about 40° C.

The prepared ozone water (2 mL) is added to the obtained two-phase solution while stirring by a magnetic stirrer for 1 hour. The resultant organic phase substance and water phase (two-phase solution) are separated by a separation funnel and analyzed by XPS and SIMS. It was found that vanadium was removed from the organic phase substance into the water phase.

More specifically, a reduction of vanadium concentration in the organic phase substance was found to be about −73%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

### Embodiment 42

The ozone-containing water phase is prepared by UV rays irradiation using high-pressure mercury vapor lamp in a water phase saturated with oxygen. An organic phase substance solution (3 mL) of about 52 ppm in concentration originating from vanadyl (IV) meso-tetraphenylporphin dissolved in toluene, accompanying a mixture of pure water (1 mL) containing a small amount of sulfuric acid (10 mM) and acetone (1 mL) is subjected. The two-phase solution is maintained at a temperature of about 40° C.

The prepared ozone water (2 mL) is added to the obtained two-phase solution while stirring by a magnetic stirrer for 1 hour. The resultant organic phase substance and water phase (two-phase solution) are separated by a separation funnel and analyzed by XPS and SIMS. It was found that vanadium was removed from the organic phase substance into the water phase.

More specifically, a reduction of vanadium concentration in the organic phase substance was found to be about −54%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

### Embodiment 43

The ozone-containing water phase is prepared by UV rays irradiation using high-pressure mercury vapor lamp in a water phase saturated with oxygen. An organic phase substance solution (3 mL) of about 52 ppm in concentration originating from vanadyl (IV) meso-tetraphenylporphin dissolved in toluene, accompanying pure water (milliQ) of 1 mL containing a benzophenone derivative of the organic carbonyl analogues, i.e., 4-benzoyl benzoate (100 mg) and DMF (0.2 mL) is subjected. The two-phase solution is maintained at a temperature of about 40° C.

The prepared ozone water (2 mL) is added to the obtained two-phase solution while stirring by a magnetic stirrer for 1 hour. The resultant organic phase substance and water phase (two-phase solution) are separated by a separation funnel and analyzed by XPS and SIMS. It was found that vanadium was removed from the organic phase substance into the water phase.

More specifically, a reduction of vanadium concentration in the organic phase substance was found to be about −57%. An appropriate amount of vanadium oxide is crystallized or solidified and collected from a water phase by vaporizing water.

As described above, by allowing an organic phase substance to coexist with a water phase and contacting at least a mixture of oxygen-containing oxidizer or oxidizers and organic carbonyl analogue or analogues with the organic phase substance, it is possible to extract or deposit one of the heavy element species, vanadium, from the organic phase substance into the water phase.

These results revealed that the processing method for extracting or depositing and/or collecting vanadium oxide as a heavy element species, and/or organic components of asphaltene and/or inorganic substance from an organic phase substance, using halogen-containing chemical or chemicals, particularly, chlorine-containing chemical or chemicals, or a mixture of oxygen-containing oxidizer or oxidizers and organic carbonyl analogue or analogues, or a mixture of hydrogen peroxide and an organic acid, or a mixture of ozone and an organic carbonyl analogue or analogues, or a mixture of ozone and hydrogen peroxide or an oxidizer or oxidizers between chlorine gas and hydrogen peroxide, or another mixture, i.e., one or a mixture of two or more chemicals selected from the chemical or the chemicals described in any one of items (1) to (16), while accompanying water alone, or accompanying water, added DMF, a nitrogen organic compound such as an amine derivative and an organic acid such as acetic acid, sufficiently works in mild environmental conditions: less than 100° C. and less than 10 atm., more specifically, a temperature of less than +30° C. and atmospheric pressure of about 1 atm. The results of removing (reducing) a vanadium species according to items (1) to (16) using a liquid-state organic phase substance are collectively described in Table 1.

It is evident that chlorine-containing chemical or chemicals work effectively and the other chemical or chemicals remove the heavy element species in the moderate of removal efficiency including catalytic reactions. The obtained results for removing and collecting can be improved by changing reaction conditions and/or adapting multi-stage and/or cyclic and/or parallel lines.

Apparatuses, instruments, and plant in the present invention for removing and/or collecting said heavy element species from organic phase substance is exemplified by the following description and examples, however, the concept of invention presented here is not limited by the description and examples following below. The other methods and procedures, or changed, or modified methods, procedures, apparatus-, instrument-, and plant-structures or means within the concept of the invention presented here, are all included in the invention claimed in the present invention.

### Embodiment 44

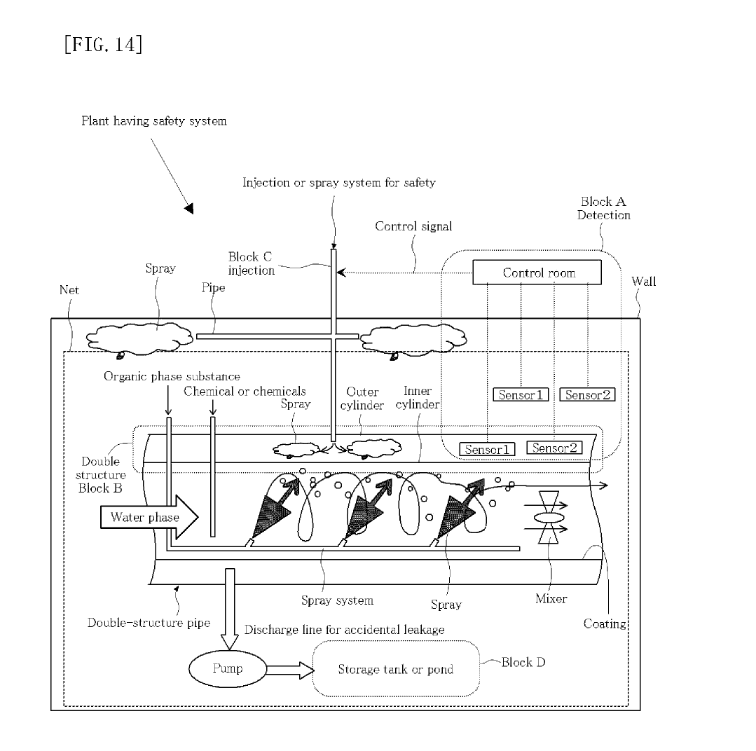

FIGS. 14 to 18 are an illustrating one embodiment on safety and, contacting or mixing the chemical or the chemicals claimed in the present invention, of apparatuses, instruments, and plant, in the process for removal and collection of heavy element species of the present invention, that is crucial from the processing and safety.

The plant of the invention having a safety system is a processing plant for removing and/or collecting the heavy element species having a safety system selected from the following blocks A to D.

Block A is an apparatus for detecting chemical or chemicals, that is, a sensor and/or a sensing control room for checking leakage of gas in the atmosphere or heavy element species in water or soil, or other contaminants, as shown in FIGS. 14 to 18.

Block B is a pipe having a double-wall structure, a wall or a net or a storage, or a plant or a factory covered with a dome for preventing leakage of a gas or heavy element species or other contaminants, as shown in FIGS. 14 to 18.

Block C is a closed structure using water and explosion avoidance structure, equipped with an injection system or spray system for nitrogen gas for preventing oxidative explosion of a gas, or a weak alkali and/or a reducing agent for neutralizing hazardous acid or halogen gas, as shown in FIGS. 14 to 18.

Block D is a storage tank or a reservoir for handling leaked chemical or chemicals and organic phase substance, in view of safety and environmental concern. The leaked substances, etc., are suctioned by a pump and stored.

For example, pipe structures are shown in FIGS. 14 to 18, basically equipped with wall or net or factory surrounding processing plants including apparatuses and instruments and plants, and sensors and control room to check chlorine (e.g., sensor 1) and hydrogen gas (e.g., sensor 2) inside and/or outside the pipe of double-wall structure.

If something leak or danger situation happens, nitrogen gas and/or solutions of weak alkali and/or reducing reagents to neutralize are injected or spray into the pipes, and/or into the inside wall or net or factory, and obtained solution is collected in the stock place such as tank or pond for the safety temporarily.

In the control room or check place for safety, protective clothing, full-face masks and gloves, electric power backup systems and manual modes requiring no electric power, e.g., a color change detection system for checking leakage of chemical or chemicals using a telescope in combination with a manual valve for operating opening/closing from outside the wall should be stored.

This kind of safety system can be installed and included in all plant structures, apparatuses, instruments, plant, reactor, tank, pipe, and trench in the present invention. The methods upon how to contact and mix chemical or chemicals in the present invention with organic phase substance adopt any kinds of procedure and structure, e.g., FIG. 14 shows a structure of pipe and apparatus for removing heavy element species from organic phase substance, which is liquid, where spray system is used to enhance mixing efficiency, with a mixer.

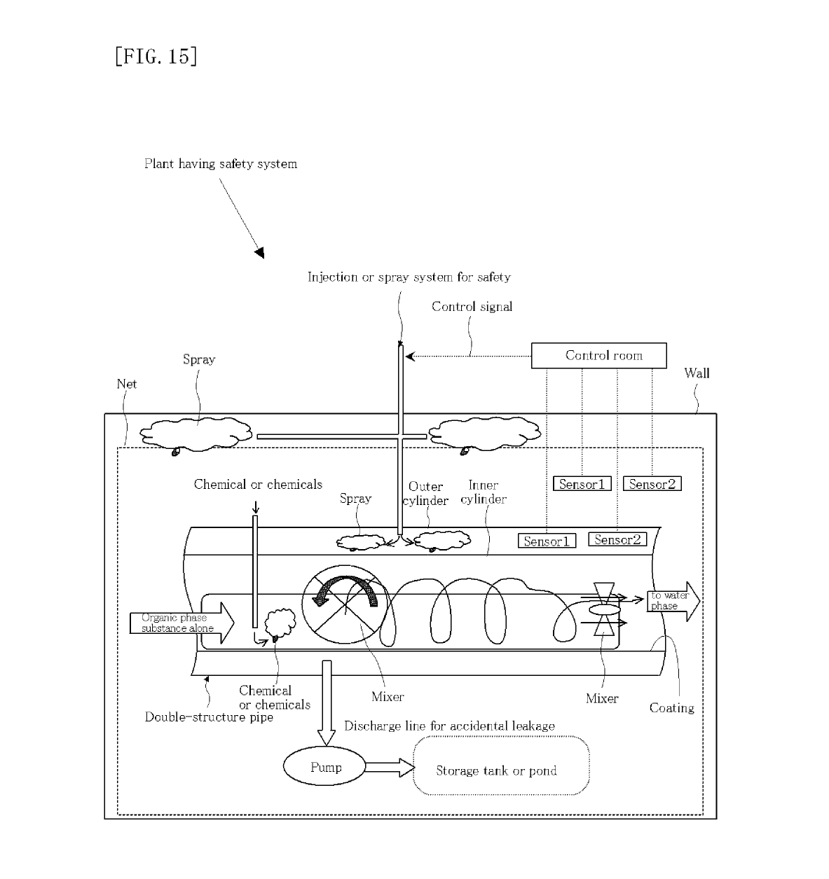

FIG. 15 shows a structure of pipe and apparatus for directly mixing organic phase substance, which is liquid, with chemical or chemicals in an initial step using a mixer, where the chemical or the chemicals are directly injected into the liquid phase of organic phase substance.

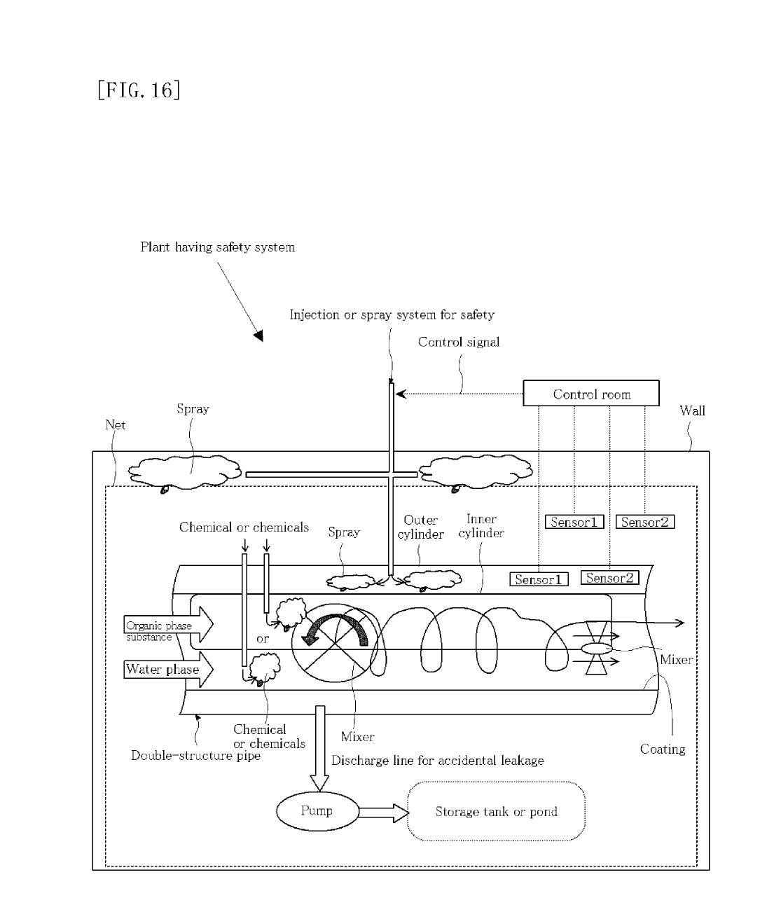

FIG. 16 shows a structure of pipe and apparatus for removing heavy element species from organic phase substance, which is liquid, using two phase system with a mixer, where chemical or chemicals are injected into one of two phases consisting of organic phase substance which is liquid and water phase, that chemical injection procedure is selected depending on plant users.

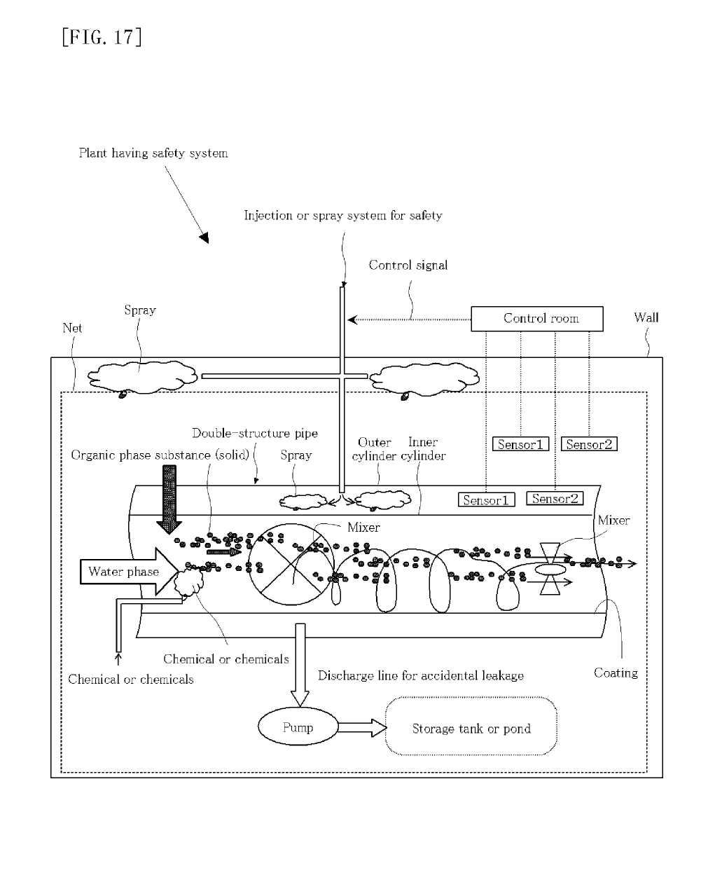

FIG. 17 shows a structure of pipe and apparatus for removing heavy element species from organic phase substance, which is solid, where the ground solid phase of organic phase substance is mixed in the water phase including chemical or chemicals with a mixer.

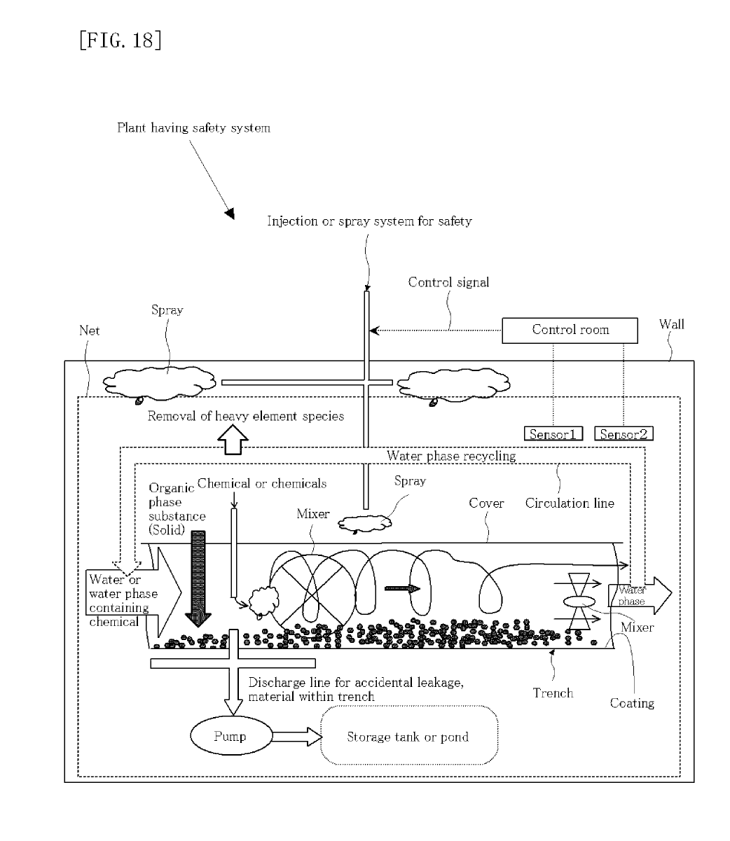

FIG. 18 shows a structure of pipe and apparatus for removing heavy element species from organic phase substance, which is solid, with a mixer, where the ground solid phase of organic phase substance is mostly arranged at the bottom of trench and the water phase is recycled in the system to enhance the removal efficiency.

### Embodiment 45

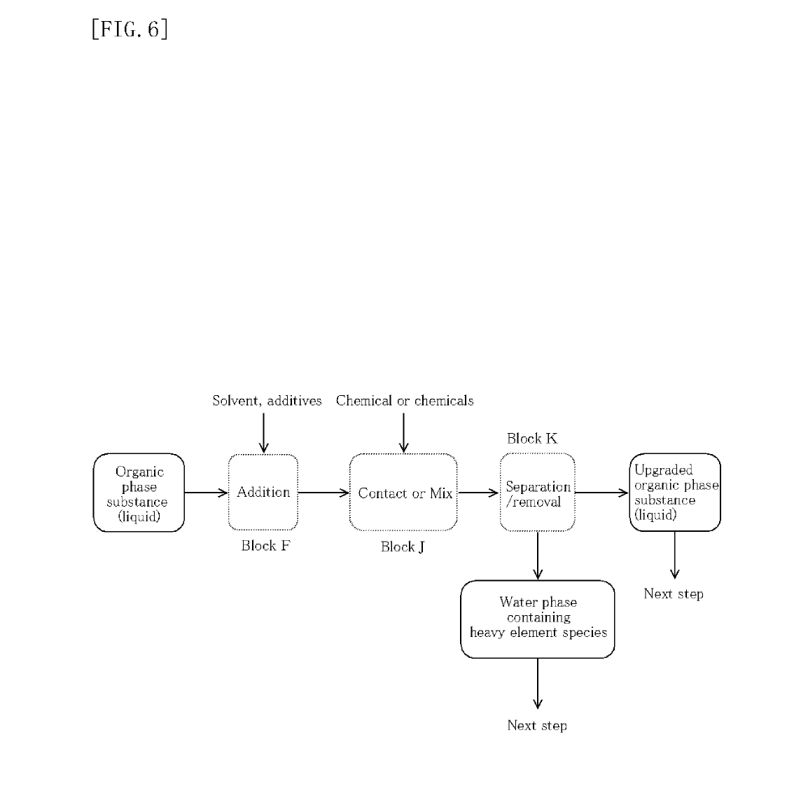

FIG. 6 is an essential block diagram illustrating one embodiment of plant for removal and collection of heavy element species from organic phase substance, which is liquid, such as bitumen, crude oil, and/or tar in the present invention.

Block F is an apparatus equipped with pipes or trenches, and mixer to add solvent such as naphtha, petroleum, crude oil, water, and/or the other solvents, and/or additives selected from alkali metal ions and/or alkali earth metal ions, nitrogen-organic compounds and/or organic acid derivatives into organic phase substance, which is liquid.

Block J is a plant to contact or mix one or a mixture of two or more selected from the chemical or the chemicals described in any one of items (1) to (16), with said organic phase substance, which is liquid, accompanying water phase, to remove heavy element species.

Block K is a plant to separate essentially organic phase substance and water phase, and/or possibly organic components of asphaltene and/or inorganic materials from the reaction mixture after contacting or mixing said chemical or chemicals with said organic phase substance.

The present invention is directed to a plant for use in the processing method according to any one of items (1) to (16) and (21) at least including them.

The present invention has a facility or apparatus or plant from which the finally obtained heavy element species and refined organic phase substance are sent as a resource or substance for a next step or for storing them.

### Embodiment 46

The invention of the plant is supplemented and expanded by the following description and examples, however, the concept of invention presented here is not limited by the description and examples following below. The other methods and procedures, or changed, or rearranged methods and procedures within the concept of the invention presented here, are all included in the invention claimed in the present invention.

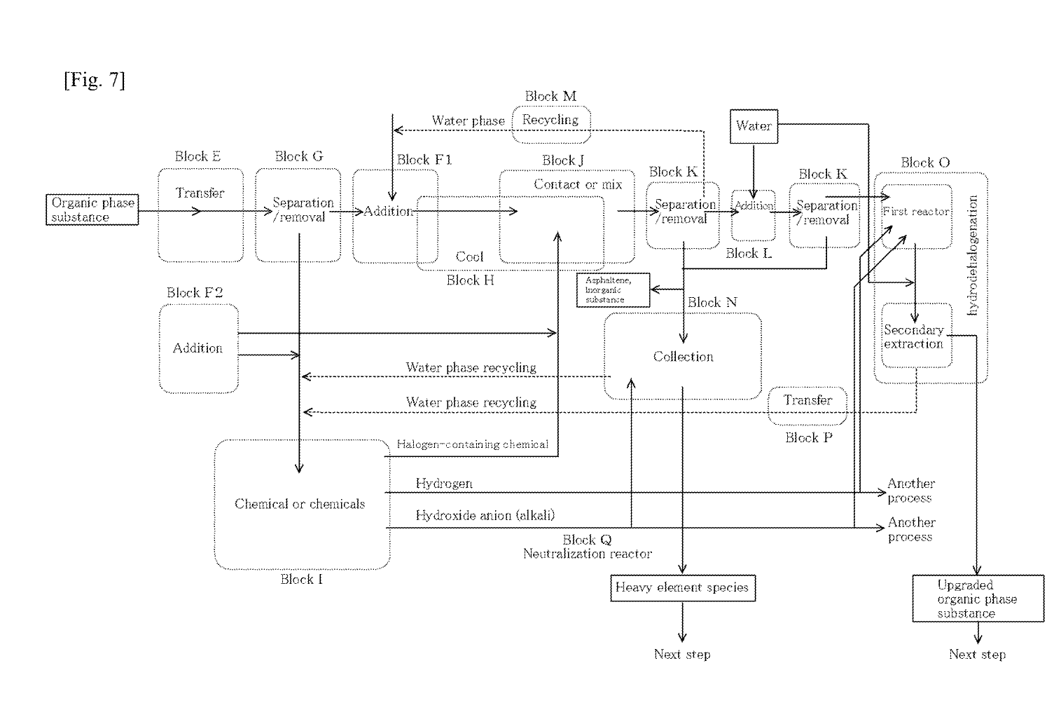

The invention of the plant is, for example, as shown in the diagram of FIG. 7, where Blocks selected among from Blocks E to Q are appropriately connected each other in each process.

Whole system is a processing plant for removing and/or collecting said heavy element species from organic phase substance such as bitumen, tar, asphaltene, or petroleum residue before/after processing, and the obtained heavy element species and refined organic phase substance is sent as a resource or a substance which is suitable to next step processes, selected among Blocks described below.

Block E is an apparatus equipped with pipes or trenches to transfer a mixture of said organic phase substance and hot water after the hot water injection to soften and mine oil sands.

Block F is an apparatus equipped with pipes or trenches and a mixer to add naphtha, petroleum, crude oil, water, and/or other solvents and/or additives selected from alkali metal ions and/or alkali earth metal ions, nitrogen-organic compounds and/or organic carbonyl analogue or analogues to a liquid-state organic phase substance.

Block G is an apparatus to separate organic phase substance of mixture of bitumen and organic solvents from water phase. Block H is an apparatus to cool down said mixture.

Block I is electrochemical apparatuses to produce chlorine-containing species, in a water phase of using arbitral aqueous solutions including solution after the usage of hot water injection to soften oil sands and tar, or solution prepared from river or lake or pond or sea water, or added with at least alkali metal chloride and/or alkali earth metal chloride, after separation of said hot water from a mixture of bitumen and said hot water, or originating from aqueous solution after hydrodehalogantion reaction, wherein said solution can be a suspension containing insoluble materials or a gas-bubbles-containing solution, and to produce hydrogen gas, which is used for hydrodehalogenation in Block O in item (28) or the other process, and to produce hydroxide anion (alkali), which is used in Block Q in this item (28), or the other process.

Block J is a plant to contact or mix one or a mixture of two or more selected from the chemical or the chemicals described in any one of items (1) to (16) with said organic phase substance consisting of bitumen or tar to remove heavy element species.

Note that the plant is constituted such that, to remove heavy element species (block J), one or a mixture of two or more selected from the chemical or the chemicals described in any one of items (1) to (16) are contacted or mixed with the liquid-state organic phase substance containing bitumen or tar. Specific procedure how to contact or mix the chemical or the chemicals is not a matter of concern. No matter how the chemical or the chemicals are contacted or mixed, it is sufficient as long as the chemical or the chemicals can be appropriately contacted or mixed with the organic phase substance as principally shown in FIGS. 14 to 18.

Furthermore, the amount of the precipitations in the process of plant can be controlled by amount of said chemical or chemicals, temperature, and how to contact and mix the said chemical or the said chemicals into organic phase substance.

As shown in FIG. 14, organic phase substance, which is liquid, is sprayed out into water phase including said chemical or said chemicals to realize the effective removal due to the enhancement of contacting area between the organic phase substance and said chemical or said chemicals.

As shown in FIG. 15, a liquid-state organic phase substance including a small amount of water is mixed with gaseous chemical or chemicals such as chlorine and bromine. In this case, the mixture is subsequently transferred to a next step and contacted with water phase. This method has an advantage of preventing production of a strong acid such as hydrochloric acid and hydrobromic acid, because most of all chemical or chemicals are consumed in the mixture of the liquid-state organic phase substance and the chemical or the chemicals, in the first step (where the chemical or the chemicals are injected into the organic phase substance) as shown in FIG. 15.

As shown in FIG. 16, since a liquid-state organic phase substance is allowed to coexist with a water phase from the beginning, in other words, since an organic phase substance accompanying a water phase is used, this method has an advantage of requiring no separation step of a water phase and an organic phase substance after a process for injecting warm water or after a process using water. The chemical or the chemicals can be mixed with a liquid-state organic phase substance or a water phase, or can be mixed with both of them depending upon the plant design.

FIG. 17 shows the removal of heavy element species from organic phase substance, which is solid, in water phase including said chemical or said chemicals. Water phase is effectively mixed by using mixers.

As shown in FIG. 18, ground organic phase substance, which is solid, can be positioned at the bottom of trench where water phase including said chemical or said chemicals is flowing in a cyclic line, which leads to effective removal of heavy element species from organic phase substance, which is solid, because of repeated and accumulated water phase flowing reactions in the process structure as shown in FIG. 18.

Block K is a plant to essentially separate an organic phase substance and a water phase, and/or possibly organic components of asphaltene and/or inorganic substances from the reaction mixture after the chemical or chemicals are contacted or mixed with the organic phase substance.

Block L is a plant to add and mix an additional fresh batch of water originating from an arbitral aqueous solution, such as the solution obtained after warm water is injected to soften oil sands and tar in order to re-extract heavy element species or a solution prepared from a river or lake or pond or sea water of an actual industrial land, to the organic phase substance separated after the reaction. The additional fresh batch of water is used as needed to remove heavy element species from the organic phase substance into a water phase and is useful to enhance the efficiency of removal.

Block M is a plant to recycle all or partial organic solvents and water used in all processing plants.

Block N is a plant to collect heavy element species such as vanadium oxide species and nickel ions from water phase by means of precipitation, and/or dissolving, and/or crystallization, and/or washing, and/or adsorption, and/or filtering using sand, or oxide powder, or ion exchange resin and reverse osmosis membrane and the like; or to collect heavy element species or alloys by plating techniques from said water phase.

Block O is a plant for hydrodehalogenation after the removal of heavy element species from said organic phase substance including bitumen or tar; said plant consisting of firstly a first reactor for hydrodehalogenation using said alkali and hydrogen gas or said alcohol, and said transition metal catalysts, and secondly a water-added system (secondary extraction) to extract salts including alkali metal chloride and/or alkali earth metal chloride.

Block P is a plant to transfer said extracted salts including alkali metal chloride and/or alkali earth metal chloride back to said electrochemical instruments.

Block Q is an apparatus equipped with pipes or trenches, and mixer to neutralize acidic water in the plant provided with said whole system according to item (28), and/or to react in said first reactor in Block O by using hydroxide anion (alkali) generated by electrolyte.

Finally, obtained heavy element species and refined organic phase substance are sent or stocked as a resource to, or a substance for next step.

### Embodiment 47

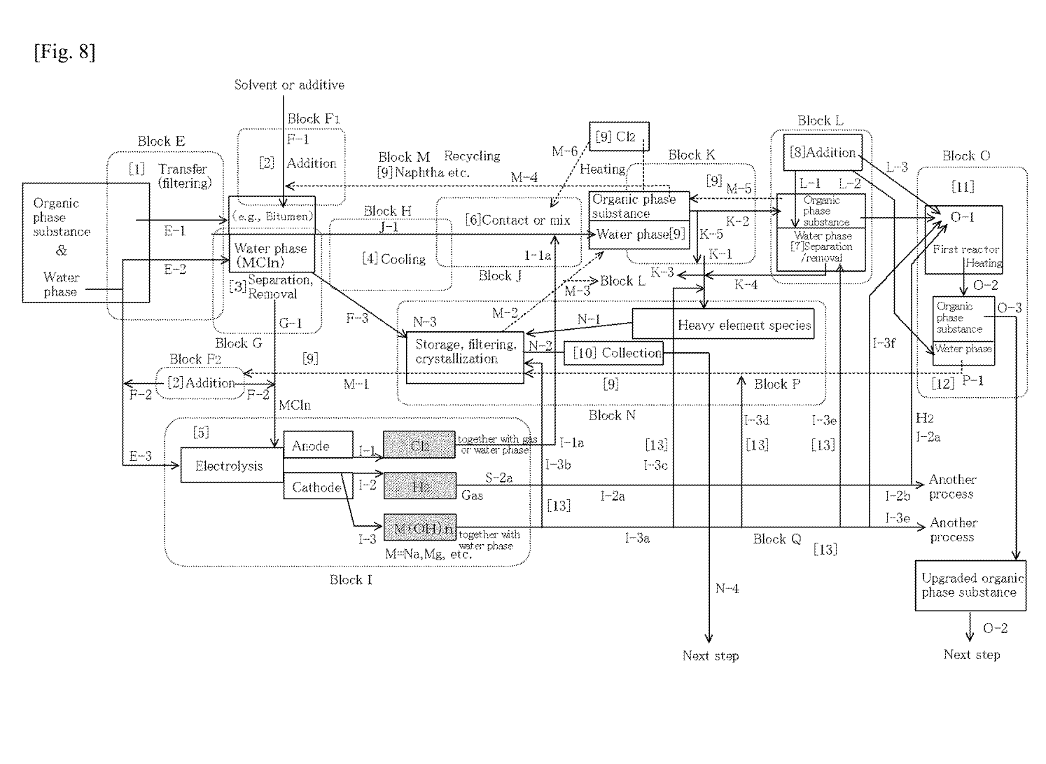

FIG. 8 shows one embodiment of a more developed structure of plant including apparatuses and instruments, and plant, of the process for removal and collection of heavy element species using chlorine-containing chemical or chemicals of the present invention.

The structure, individual blocks shown in FIG. 8, are mutually appropriately connected in each process and designed so as to remove and collect heavy element species from an organic phase substance such as bitumen, crude oil, tar and/or the like. The heavy element species is sent or transferred, after completion of processing, to a next-step processing as a resource or a valuable material. And the structure is also designed so as to provide a refined organic phase substance with a reduced viscosity and/or reduced quantity of heavy element species such as vanadium, nickel, and/or copper species. After completion of the processing, the organic phase substance is sent or transferred, to a next-step processing including crude oil distillation, coking and thermal processes, catalytic cracking, catalytic hydrogenolysis, hydrogenation, residual oil processing, hydrogenation processing, catalytic reformation and catalytic isomerization. The structure consists of what is described following below.

At the process method [1] (transfer, filtering) corresponding to Block E,

Organic phase substance, e.g., oil sands or bitumen, accompanying water, which have been produced in any oil sand extraction processes known in the art, is transfer using transfer route E-1 such as pipe or trench, including several filtering steps to remove soil, plants, tips, sands, clay, or tailing in advance, a water can be added if necessary using transfer route E-2 such as pipe or trench in the case of little amount of accompanying water phase or a process of all organic solvent system with no water phase.

At the process method [2] (addition) corresponding to Block F,

organic solvents and necessary additives, e.g., nitrogen-organic compounds or organic acid derivatives are added in Block F₁, on the other hand, salts including at least alkali metal chloride and/or alkali earth metal chloride is added through pipeline F-2, if necessary, at the process method [2] in Block F₂.

Organic phase substance after the process method [1] is initially sent to the process method [3] (separation system) in Block G and the process method, addition system of organic solvents in Block F₁, where organic phase substance is diluted with an appropriate organic solvent, and extracted, separated from water, and sent to transfer route J-1 of pipeline, all or a part of the water phase is sent through G-1 to the next electrolysis. Necessary additive are added after the addition of organic solvent. In the case of little amount of accompanying water phase or a process of all organic solvent system with no water phase, the process method [3] is skipped, and organic solvents are added to the organic phase substance through F-1 in Block F₁.

At the process method [5] (electrolysis) corresponding to Block I,

This block I is basically connected with a pipe of G-1 in the case of process of [3], or with a pipe of E-3 in the case of little amount of accompanying water phase or a process of all organic solvent system with no water phase. In the latter case, block I directly uses an obtained or prepared water at an actual industry site, without the process method [3], separation system.

Before electrolysis reaction, at the process method [2] in Block F₂, where salts including at least alkali metal chloride and/or alkali earth metal chloride is added through pipeline F-2.

To the water phase on the way of G-1 are added said salts if necessary, to the water phase on the way of G-1 are added said salts if necessary in the case of little amount of accompanying water phase or a process of all organic solvent system with no use in Block E.

Anode and cathode electrodes is set n Block I for electrolysis reaction, in reaction cell, trench, or pool, I-1 and I-2,3 respectively, where it is preferable to use separation system consisting of ion-exchange polymer films between anode and cathode electrodes.

To anode electrodes of apparatuses applied an appropriate positive voltage to produce chlorine-containing chemical or chemicals, as a gas or a solution including chlorine-containing chemical or chemicals with water phase, using a water phase from the pipeline G-1 or E-1 including any kind of aqueous solutions such as solution after the usage of hot water injection to soften oil sands and tar, or solution prepared from river or lake or pond or sea water as it is, or added at least alkali metal chloride and/or alkali earth metal chloride, after separation of said hot water from a mixture of bitumen and said hot water. The obtained chlorine-containing chemical or chemicals in I-1 is transferred to pipeline I-1a which connects into a reaction place for the process method [6] in Block J.

To cathode electrodes of apparatuses applied an appropriate negative voltage to produce hydrogen H₂ as a gas and an alkali solution including hydroxide anion such as sodium hydroxide and/or magnesium hydroxide with water phase in a reaction cell, trench, or pool (I-2), which is transferred to next pipelines such I-2a, b and I-3a-f. Some of hydrogen gas is sent to use in the other process through I-2b, and some of hydroxide anion is sent to use in the other process through I-3e.

At the process method [4] (cooling) corresponding to Block H,

The mixture of organic phase substance accompanying with water phase (if necessary additives) is cooled down in advance for the next reaction in Block J, using a cooling system. It is preferable to use snow or ice or cool water around actual industry site, specifically in the case of Athabasca, north Canada.

At the process method [6] (contact, mix) corresponding to Block J,

Organic phase substance from J-1 including bitumen or tar, appropriate additives if necessary, accompanying with water phase, is contacted or mixed chlorine-containing chemical or chemicals from I-1a in Block J, where any kind of procedures and processes is performed in a reaction place such as pipe or trench structure as shown in FIGS. 14 to 18, for example; as shown in FIG. 14, organic phase substance, which is liquid, is sprayed out into water phase including said chemical or said chemicals to realize the effective removal due to the enhancement of contacting area between the organic phase substance and said chemical or said chemicals.

As shown in FIG. 15, organic phase substance, which is liquid, is mixed with gas chemical or chemicals such as chlorine and bromine, in this case subsequently the mixture is transferred to next step for contacting with water.

This method has an advantage to prevent from the production of strong acid such as hydrochloric acid and hydrobromic acid because almost chemical or chemicals are consumed in the mixture of organic phase substance, which is liquid, and said chemical or said chemicals at first step as shown in FIG. 15.

As shown in FIG. 16, organic phase substance, which is liquid, coexist with water from the beginning, which has an advantage that it is not needed to separate water phase and organic phase after the hot water injection or water-adding processing. Said chemical or said chemicals can be mixed into organic phase substance, which is liquid, or water phase, both cases are possible depending plant design.

A coating inside of pipe is needed in the case of the existence of chlorine-containing chemical or chemicals in the process, I-1, I-1a in Block I, J-1 in Block J, and M-6 and separation place in Block K, and also in the case of the existence of strong alkali in the process, I-3 in Block I, and pipelines I-3a-f.

It is preferable of the coating to use halogen—or acid—or alkali—proof materials such as Teflon—(registered trademark) or glass—or organic chloride—or polyvinylchloride (PVC)—or carbon-related coatings inside of the places such as pipe, trench, tank, pool, or plant.

At the process method [7] (separation) corresponding to Block K,

Each substance is separated by extraction and filtering techniques, e.g., water phase is separated by extraction tank or pipe or trench in Block K, which is send to next step through K-1 connected to Block N, and organic components of asphaltene and/or inorganic substances are separated by precipitating or filtering techniques from the reaction mixture toward K-3, if necessary. The process method [7] in Block K comprises the extraction system of organic phase substance, e.g., over-flow technique at the top of two phase system, organic phase substance and water phase after the reaction in Block J, simultaneously a filtering of organic phase substance is performed if necessary.

Organic phase substance processed in Block K is subsequently sent to next step, further separation in Block L, where a water phase originating from recycle system Block M, or any kind of aqueous solutions such as solution after the usage of hot water injection to soften oil sands and tar, or solution prepared from river or lake or pond or sea water or soil at actual industrial site, is added to extract heavy element species remained in organic phase substance. The obtained water phase is sent to Block N through pipeline K-4. The washed organic phase substance is transferred to a first reactor in Block O.

At the process method [10] (collect) corresponding to Block N,

Water phase after the process in Block J, K, and L is gathered and heavy element species such as vanadium oxide species, nickel ions, or the other metal species is collected from the water phase using precipitation, and/or dissolving, and/or crystallization, and/or washing, and/or adsorption, and/or filtering using sand, or oxide powder, or ion exchange resin and reverse osmosis membrane, or collected as heavy element species, elements, or alloys by electrochemical reactions on cathode, plating techniques from said water phase. Some of the water phase is stocked in tank or pond if necessary, and these are sustainably recycled in plant area as much as possible.

At the process method [9] (recycle) corresponding to Block M as dashed lines shown in FIG. 8,

All or partial organic solvents and water phase used in all processing plants is recycled, for example, remained chlorine gas through line M-6, Naphtha as one of organic solvents through line M-4, remained organic solvents line M-5, water phase through line M-2, water phase including salts through line P-1 in Block P.

At the process method [11] corresponding to Block O, Firstly organic phase substance after the process in Block L is transferred into a first reactor where hydrodehalogenation, more precisely hydrodechlorination reaction is carried out using said alkali provided from I-3f and hydrogen gas injected from I-2a or secondary alcohol such as isopropanol, and transition metal catalysts using palladium, or iridium, or platinum.

The first reactor is equipped with heater to arise the temperature in a range of from about 40 to less than 100° C. Secondly a water phase from L-2 in Block L is added to organic phase substance to extract salts including alkali metal chloride and/or alkali earth metal chloride after the reaction in reactor, which is sent to Block N or F2 for the recycling. Block O can be replaced by hydrotreating process including hydrodesulfurization and hydrodenitrogenation, or the other process using transition metal catalysts in oil sand industries.

At the process method corresponding to Block Q, Apparatus equipped with pipes or trenches are set to neutralize acidic water by using hydroxide anion (alkali) generated by Block I.

The obtained heavy element species and refined organic phase substance, e.g., refined oil are sent or transferred through line N-4 and O-4, respectively, to next step to afford a benefit for next processes, or improved substances, or users.

This structure of plant described here is applicable to the method using other chemical or chemicals, i.e., bromine-containing chemical or chemicals according to item (3), iodine-containing chemical or chemicals according to item (4), and chemicals including at least mixture of hydrogen peroxide and organic acids selected among acetic acid, and/or benzoic acid, and/or naphthoic acid derivatives, and/or maleic acid, and/or the other type of organic acids including naphthenic acids, with said organic phase substance according to any one of items (5) to (7).

Block I, F₂, and O can be left out from the plant in the case of chemicals including at least mixture of hydrogen peroxide and organic acids, these chemicals are incessantly provided from Block F₁ in this case, for example, using hydrogen peroxide and naphthenic acids produced in oil industries. The appropriate combination between Blocks from A to Q as described above comprises a processing plant using the process method according to the present invention.

### Embodiment 48

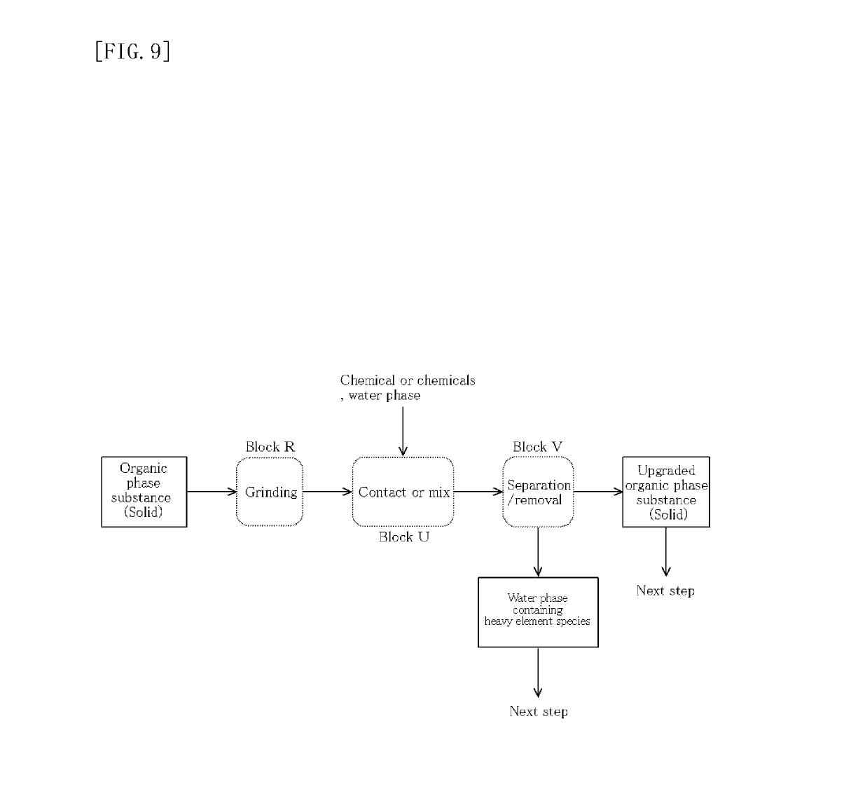

FIG. 9 is an essential block diagram illustrating one embodiment of plant for removal and collection of heavy element species from organic phase substance, which is solid, such as cokes, oil shale, and/or coal in the present invention.

Block R is an apparatus to grind organic phase substance, which is solid, including cokes or oil-shale or coal to make powders, shots, lump, or pieces, which are transferred by an apparatus such as pipes or trenches or belt conveyors.

Block U is a plant to contact or mix one or a mixture of two or more selected from the chemical or the chemicals described in any one of items (1) to (16), or a mixture of two or more said chemicals selected in claims from 1 to 4, and/or 10-12, with said organic phase substance, which is solid, accompanying water phase, to remove heavy element species.

Block V is a plant to separate or filter said powders, shots, lump, or pieces from said water phase after contacting or mixing said halogen-containing species. The present invention at least includes them.

Finally, a facility or apparatus or plant to feed the obtained heavy element species to a next step as a resource or a substance and to store or convert the reacted organic phase substance as a resource or a material is at least included.

### Embodiment 49

The invention of the plant is modified and expanded by the following description and examples, however, the concept of invention presented here is not limited by the description and examples following below. The other methods and procedures, or changed, or rearranged methods and procedures within the concept of the invention presented here, are all included in the invention claimed in the present invention.

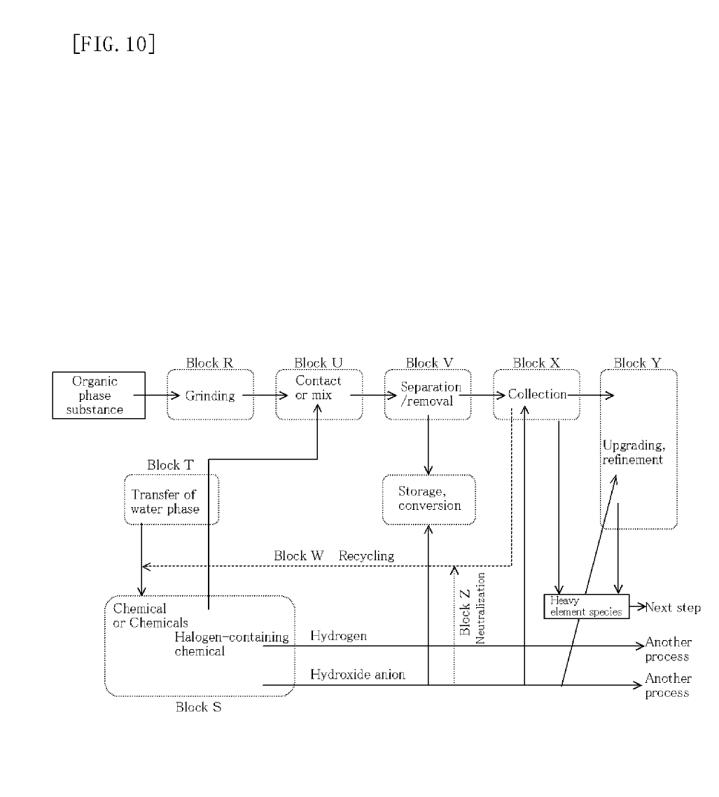

For example, as shown in the diagram of FIG. 10, blocks selected from blocks R to Z are appropriately connected to each other in each processing. The whole system is a processing plant for removing and/or collecting the heavy element species from cokes or oil-shale or coal. The obtained heavy element species are sent as a resource or a substance suitable for a next-step processing. The reacted organic phase substance is stored or converted into a resource. The plant of the invention having a safety system is selected from the following blocks.

Block R is an instrument to grind a solid-state organic phase substance including cokes or oil-shale or coal to prepare powders, shots, lump or pieces, which are transferred by an apparatus such as pipes or trenches or belt conveyors.

Block S is an electrochemical apparatus to produce the halogen-containing chemical or chemicals set forth in any one of items (1) to (5) or a mixture of two or more chemicals selected in any one of items (1) to (8), in a water phase, using an arbitral aqueous solution including the solution obtained after warm water is injected to soften oil sands and tar, or a solution prepared from a river or lake or pond or sea water or having at least an alkali metal chloride and/or an alkali earth metal chloride added thereto, and the solution obtained after the warm water is separated from a mixture of bitumen and the warm water or after a hydrodehalogenation reaction,

to produce hydrogen gas, which is used in other processes, and

to produce hydroxide anions (alkali), which are used in item (29) or in other processes and Block Z.

Block T is an apparatus equipped with pipes or trenches, and mixer to prepare and/or transfer solution prepared from river or lake or pond or sea water, or added with at least alkali metal chloride and/or alkali earth metal chloride, after separation of said hot water from a mixture of bitumen and said hot water, or originating from aqueous solution after hydrodehalogenation reaction.

Block U is a plant to remove heavy element species by contacting or mixing the halogen-containing species with a solid organic phase substance such as powders, shots, lump, or pieces accompanying a water phase or using a water phase obtained from an arbitral aqueous solution, including the solution obtained after warm water is injected to soften oil sands and tar, or a solution prepared from a river or lake or pond or sea water.

Block V is a plant to separate or filter said powders, shots, lump, or pieces from said water phase after contacting or mixing said chemical or said chemicals, to transfer the filtrates after separation or filtering to next step, and to stock said powders, shots, lump, or pieces after separation or filtering.

Block W is a plant to recycle all or partial water phase used in all processing plants.

Block X is a plant to collect heavy element species such as vanadium oxide species and nickel ions from said water phase after separation or filtering, by means of precipitation, and/or dissolving, and/or crystallization, and/or washing, and/or adsorption, and/or filtering, using sand, or oxide powder, or ion exchange resin and reverse osmosis membrane, or a plant to collect heavy element species or alloys by plating techniques from said water phase.

Block Y is a plant for upgrading heavy element species from the collected mixture after processing, firstly upgrading or recrystallization of each heavy element species and secondly dissolving, plating, washing, or reactions of refined heavy element species including alloys to obtain the corresponding upgraded heavy element species or alloy.

Block Z is an apparatus equipped with pipes or trenches, and mixer to neutralize acidic water in said whole system according to item (29), and/or said powders, shots, lump, or pieces after separation or filtering by using hydroxide anion (alkali) generated by electrolyte.

The present invention has a facility or apparatus or plant, which feeds the finally obtained heavy element species as a resource or a substance to a next step and in which the refined organic phase substance is stored as or converted into a resource or a material. The present invention is selected from them.

### Embodiment 50

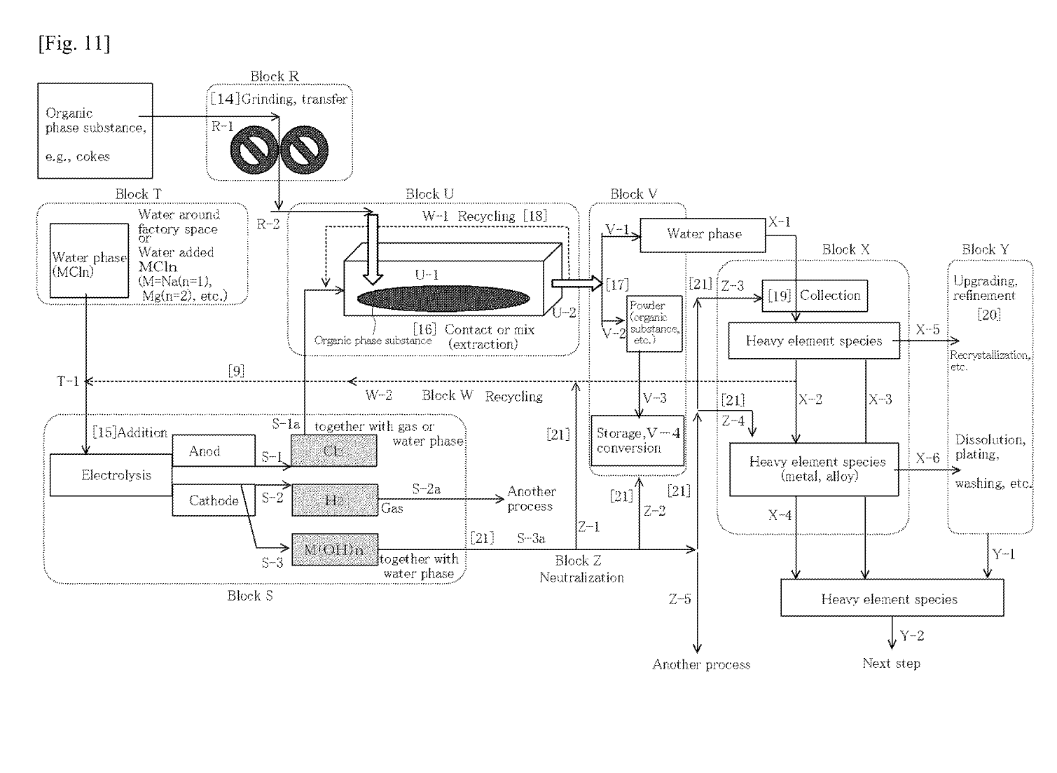

FIG. 11 shows a developed structure of a plant including apparatuses and instruments used in a process for removing and collecting the heavy element species by using the chlorine-containing chemical or chemicals of the present invention and an embodiment of the plant.

The structure, individual blocks shown in FIG. 11 are mutually appropriately connected in each process and set in order to remove and collect heavy element species from an organic phase substance such as cokes, oil-shale or coal and/or the like. The heavy element species is sent or transferred, after completion of the processing, to a next-step processing as a resource or a valuable material. The structure consists of that described following below.

At the process method [14] (transfer, filtering) corresponding to Block R,

Organic phase substance, e.g., cokes or oil shale, is transfer using transfer route R-1 such as pipe or trench or belt-conveyer, including several filtering or separation steps such as washing and flotation to remove soil, plants, tips, sands, clay, or tailing in advance, to be ground using a grinder as shown in FIG. 11. After grinding, ground organic phase substance such as powders, shots, lump, or pieces, with the diameter less than for example 1 cm in this case, is sent to next step with R-2 connected to Block U.

At the process method corresponding to Block T, Water phase including at least alkali metal chloride and/or alkali earth metal chloride, originating from hot water injection, is used and transferred in T-1, or salts including at least alkali metal chloride and/or alkali earth metal chloride are added in advance, if necessary, using solution prepared from river or lake or pond or sea water, or water phase after separation of said hot water from a mixture of bitumen and said hot water, or originating from aqueous solution after hydrodehalogenation reaction.

At the process method (electrolysis) corresponding to Block S,

This Block S is connected with a pipe or a trench of T-1 in this process accompanying water, which is added from T-1 at process method [15] in Block S. Block S can directly use an obtained water or prepared water phase at an actual industry site.

Before electrolysis reaction, at the process method [15] in Block S, salts including at least alkali metal chloride and/or alkali earth metal chloride and/or the other appropriate additives is added if necessary.

Anode and cathode electrodes is set n Block S for electrolysis reaction, in reaction cell, trench, or pool, S-1 and S-2,3 respectively, where it is preferable to use separation system consisting of ion-exchange polymer films between anode and cathode electrodes. To anode electrodes of apparatuses applied an appropriate positive voltage to produce chlorine-containing chemical or chemicals, as a gas or a solution including chlorine-containing chemical or chemicals with water phase, using a water phase from the pipeline T-1 including any kind of aqueous solutions such as solution after the usage of hot water injection to soften oil sands and tar, or solution prepared from river or lake or pond or sea water as it is, or added at least alkali metal chloride and/or alkali earth metal chloride, after separation of said hot water from a mixture of bitumen and said hot water. The obtained chlorine-containing chemical or chemicals in S-1 is transferred to pipeline S-1a which connects into a reaction place for the process method [16] in Block U.

To cathode electrodes of apparatuses applied an appropriate negative voltage to produce hydrogen H2 as a gas and an alkali solution including hydroxide anion such as sodium hydroxide and/or magnesium hydroxide with water phase in a reaction cell, trench, or pool (S-2), which is transferred to next pipelines such S-2a and S-3a, and Z-1 to Z-5. Some of hydrogen gas is sent to use in the other process through S-2a, and some of hydroxide anion is sent to use in the other process through Z-5.

At the process method [16] (contact, mix) corresponding to Block U,

Organic phase substance from R-2 is contacted or mixed chlorine-containing chemical or chemicals in water phase from S-1a in Block U, where the water phase is heated at the temperature in a range of from about 40 to less than 100° C., and any kind of procedures and processes are performed in a reaction place such as pipe or trench structure as shown in FIGS. 17 and 18, for example; FIG. 17 shows the removal of heavy element species from organic phase substance, which is solid, in water phase including said chemical or said chemicals. Water phase is effectively mixed by using mixers. As shown in FIG. 18, ground organic phase substance, which is solid, can be positioned at the bottom of trench where water phase including said chemical or said chemicals is flowing in a cyclic line (W-1), removing heavy element species from water phase, e.g., collecting heavy element species by using reverse osmosis membrane, (the process method [18] using cyclic trench for example), which leads to effective removal of heavy element species from organic phase substance, which is solid, because of repeated and accumulated water phase flowing reactions in the process structure as shown in FIG. 18.

A coating inside of pipe is needed in the case of the existence of chlorine-containing chemical or chemicals in the process, S-1, S-1a in Block S, U-1 in Block U, and W-1 and separation place in Block V, and also in the case of the existence of strong alkali in the process, S-3a in Block S, and pipelines Z-1 to f5. It is preferable of the coating to use halogen—or acid—or alkali—proof substances such as Teflon—(registered trademark) or glass—or organic chloride—or polyvinylchloride (PVC)—or carbon-related coatings inside of the places such as pipe, trench, tank, pool, or plant.

At the process method [17] (separation) corresponding to Block V,

Each substance is separated by filtering techniques, e.g., water phase is separated by filtering in tank or pipe or trench in Block V, which is send to next step through X-1 connected to Block X. Organic phase substance, organic components of asphaltene and/or inorganic substances are separated by precipitating or filtering techniques from the reaction mixture toward V-2, if necessary. The obtained solids are further separated by a centrifugal force in the process method [17] in Block V, and washed by washing system with water phase through V-3, which is stocked in V-4. If necessary, these solids are converted into valuable substances.

Water phase substance processed in Block V is subsequently sent to next step, collection system in Block X, where heavy element species such as vanadium oxide species, nickel ions, or the other metal species is collected from the water phase using precipitation, and/or dissolving, and/or crystallization, and/or washing, and/or adsorption, and/or filtering using sand, or oxide powder, or ion exchange resin and reverse osmosis membrane, or collected as heavy element species, elements, or alloys by electrochemical reactions on cathode, plating techniques from said water phase. Some of the water phase is stocked in tank or pond if necessary, and these are sustainably recycled in plant area as much as possible, e.g., using cyclic trench system W-1 at the process method [18] and pipeline W-2 at the process method [9].

At the process methods [9] and [18] (recycle) corresponding to Block W as dashed lines shown in FIG. 11, All or partial organic solvents and water phase used in all processing plants is recycled, for example, remained chlorine gas through line W-1, water through line W-2.

At the process method [20], further upgrading, corresponding to Block Y,

Further upgrading is performed for oxidized heavy element species using dissolving in aqueous solution, and recrystallization or reprecipitation after transport through X-5. Furthermore plating techniques are carried out after transport through X-6 to afford heavy element species, elements or alloys from aqueous solution including heavy element species ions.

At the process method corresponding to Block Z, Apparatus equipped with pipes or trenches Z-1 to 5 are set to neutralize acidic water by using hydroxide anion (alkali) generated by Block Z.

The obtained heavy element species through X-2 to 4, and Y-1, which are saleable, are sent or transferred through Y-2, respectively, to next step to afford a benefit for next processes, or improved substances, or users.

This structure of plant described here is applicable to the method using other chemical or chemicals, i.e., bromine-containing chemical or chemicals according to item (3), iodine-containing chemical or chemicals according to item (4), and chemical or chemicals including at least mixture of hydrogen peroxide and organic acids selected among acetic acid, and/or benzoic acid, and/or naphthoic acid derivatives, and/or maleic acid, and/or the other type of organic acids including naphthenic acids, with said organic phase substance according to any one of items (5) to (7).

The appropriate combination between Blocks from A to D, and R to Z as described above comprises a processing plant using the process method according to the present invention.

Table 1 shows the removal (reduction) rate (%) of vanadium (V) from an organic phase substance. Note that Em represents an Embodiment and the number of Embodiment corresponds to the number of Em.

[Table 1]

### REFERENCE SIGNS LIST

1 Organic phase substance
2 Water phase
3 Chemical or chemicals
3a Chlorine line
4 Mechanical stirrer
5 Inlet
6 Outlet
7 Reaction pot
8 Dropping funnel
9 Dry nitrogen
10 Thermometer
11 Discharge gas trap
12 Three-neck glass vessel
13 Processing unit for organic phase substance

1. A method for processing an organic phase substance, comprising:
allowing an organic phase substance to coexist with a water phase, wherein the organic phase substance contains at least organic components originating from one or more selected from crude oil, bitumen, tar, residual fuel oil, petroleum residue, oil sands, tar-sand, asphaltene, fossil strata, cokes, oil-shale and coal, and contacting resultant of the above coexistence with halogen-containing chemical or chemicals, thereby extracting or depositing the heavy element species from the organic phase substance into the water phase.

2. The method for processing an organic phase substance according to claim 1, wherein the halogen-containing chemical or chemicals include at least one chlorine-containing chemical or more chlorine-containing chemicals selected from chlorine gas, chlorofluorides or an interhalogen compound selected from bromine monochloride or iodine monochloride, a chlorine radial and a chlorine oxide.

3. The method for processing an organic phase substance according to claim 1, wherein the halogen-containing chemical or chemicals include at least one bromine-containing chemical or more bromine-containing chemicals selected from bromine gas, bromine liquid, bromine-containing interhalogen compounds, bromine radicals and bromine oxides.

4. A method for processing an organic phase substance, comprising:
allowing an organic phase substance to coexist with a water phase, wherein the organic phase substance contains at least organic components originating from one or more selected from crude oil, bitumen, tar, residual fuel oil, petroleum residue, oil sands, tar-sand, asphaltene, fossil strata, cokes, oil-shale and coal; and
contacting resultant of the above coexistence with oxygen-containing oxidizer or oxidizers, and organic carbonyl analogue or analogues, thereby extracting or depositing the heavy element species into the water phase.

5. The method for processing an organic phase substance according to claim 1, wherein, to the water phase, a nitrogen organic compound is added in a concentration of less than 15%.

6. A refined organic phase substance processed and produced by the method for processing an organic phase substance according to claim 1.

7. Heavy element species collected from a water phase processed by the method for processing an organic phase substance according to claim 1.

8. The method for processing an organic phase substance according to claim 2, wherein, to the water phase, a nitrogen organic compound is added in a concentration of less than 15%.

9. The method for processing an organic phase substance according to claim 3, wherein, to the water phase, a nitrogen organic compound is added in a concentration of less than 15%.

10. The method for processing an organic phase substance according to claim 4, wherein, to the water phase, a nitrogen organic compound is added in a concentration of less than 15%.

11. A refined organic phase substance processed and produced by the method for processing an organic phase substance according to claim 2.

12. A refined organic phase substance processed and produced by the method for processing an organic phase substance according to claim 3.

13. A refined organic phase substance processed and produced by the method for processing an organic phase substance according to claim 4.

14. Heavy element species collected from a water phase processed by the method for processing an organic phase substance according to claim 2.

15. Heavy element species collected from a water phase processed by the method for processing an organic phase substance according to claim 3.

16. Heavy element species collected from a water phase processed by the method for processing an organic phase substance according to claim 4.
